(19) United States
(12) Patent Application Publication
(10) Pub. No.: US 2017/0045853 A1
(43) Pub. Date: Feb. 16, 2017

(54) SHEET FEEDING APPARATUS AND IMAGE FORMING APPARATUS

(71) Applicant: CANON KABUSHIKI KAISHA, Tokyo (JP)

(72) Inventors: Takashi Hiratsuka, Kashiwa-shi (JP); Takeshi Aoyama, Kawasaki-shi (JP); Takaaki Aoyagi, Kawasaki-shi (JP); Yasumi Yoshida, Yokohama-shi (JP); Isao Hayashi, Kawasaki-shi (JP); Hisae Shimizu, Tokyo (JP)

(21) Appl. No.: 15/305,824

(22) PCT Filed: Jun. 24, 2015
(86) PCT No.: PCT/JP2015/068929

§ 371 Date: Oct. 21, 2016

(30) Foreign Application Priority Data
Jun. 24, 2014 (JP) 2014-128759

(51) Int. Cl. G03G 15/00; B65H 7/18; B65H 3/18; B65H 7/02; B65H 1/04; B65H 1/18

(52) U.S. Cl. CPC G03G 15/6529; B65H 1/04; B65H 1/18; B65H 3/18; B65H 7/02; B65H 7/18; B65H 2801/06

(57) ABSTRACT

A sheet feeding apparatus includes a controller for shifting a sheet attractor from a stand-by state in which the attractor is away from a sheet accommodated in a sheet stacking device to an attraction state in which the attractor is elastically deformed to surface-contact with the sheet stacked on the stacker to electrostatically attract the sheet, to a separating state for separating the sheet from a lower sheet by lifting a downstream end of the sheet with respect to the feeding direction, and to a spaced state in which the attractor spaces the attracted sheet from the lower sheet, the controller changing a slackness of the attractor in the separating state on the basis of a stiffness information of the sheet.

### FIELD OF THE INVENTION

The present invention relates to a combination of a sheet feeding apparatus and an image forming apparatus, in particular, a sheet feeding apparatus which uses electrostatic force (attraction) to feed a sheet of recording medium into the main assembly of an image forming apparatus.

### BACKGROUND ART

A conventional image forming apparatus such as a copying machine, a printer, and the like is equipped with a sheet feeding device for feeding a sheet of recording medium into the main assembly of the apparatus. Some of these types of sheet feeding devices are of the so-called friction feed type. They separate the topmost sheet of recording medium from the multiple sheets of recording medium stored in layers in a cassette, with the use of the friction between a rubber roller or the like, and the topmost sheet. In the case of a sheet feeding device of the friction feed type, the topmost sheet is moved out of the cassette by rotating the rubber roller while keeping the rubber roller pressed upon the topmost sheet of recording medium in the cassette.

Also in the case of a sheet feeding device of the so-called friction feed type, it sometimes occurs that two or more sheets of recording medium are moved out of the cassette by the friction between the topmost sheet of recording medium and the second sheet from the top, friction between the second sheet from the top and the third sheet from the top, and so on. As for the countermeasure for this problem, a separation pad, a retard roller, or the like is used to generate friction between itself and the other sheets than the topmost sheet so that only the topmost sheet is conveyed to the image forming section of an image forming apparatus.

In the case of a sheet feeding device of the above described type, while a sheet of recording medium is fed into the main assembly of an image forming apparatus by a rubber roller, it remains under a large amount of pressure applied thereto by the roller. Thus, it suffers from a problem that the friction among sheets of recording medium and friction between sheets and roller generate noises. In addition, as a sheet (or sheets) of recording medium other than the topmost sheet is prevented from being fed into the main assembly of an image forming apparatus by a separation pad, a retard roller, or the like, noises resulting from the friction among sheets become rather large. Further, even when only the topmost sheet is being separated, a separation pad, a retard roller, or the like still functions as a component which prevents sheet conveyance. There occur, therefore, the so-called “stick-and-slip” noises between the separation roller, or retard roller, and the sheet (topmost sheet) which is being fed into the main assembly.

As one of the solutions to the above described frictional noises, there is a sheet feeding device which uses electrostatic force (attraction). More concretely, the device is structured so that the topmost sheet of recording medium is moved out of a sheet cassette, while being separated from the second sheet from the top, by being adhered to the outward surface of a belt by an electric field formed on the surface of the belt (Japanese Laid-open Patent Applications 2012-140224 and 2012-193010). In the case of a sheet feeding device such as the one described above, which uses electrostatic force (attraction) to separate the topmost sheet of recording medium from the second sheet from the top, it is possible to separate the topmost sheet as if it is peeled away from the rest of sheets in the cassette. Therefore, it is substantially smaller in the amount of noises attributable to the sheet feeding section than a sheet feeding device of the conventional type.

### SUMMARY OF THE INVENTION

Among conventional sheet feeding devices which use electrostatic force (attraction) to move a sheet of recording medium out of a recording medium storage, the one structured as disclosed in Japanese Laid-open Patent Application 2012-140224 is enabled to slacken the sheet attracting side of its electrostatic sheet separating section to increase the area of contact between the electrostatic sheet attracting member of the electrostatic sheet separating section and the sheet to be moved out of the sheet storage (cassette), in order to generate a sufficient amount of electrostatic force (attraction) to separate the topmost sheet. However, this sheet feeding device feeds the topmost sheet of recording medium while remaining in contact with the topmost sheet. Therefore, there still remain the noises attributable to the friction between the topmost sheet and the sheets thereunder. Further, because the electrostatic sheet separating portion of the sheet feeding device conveys the topmost sheet while remaining in contact with the topmost sheet, the sheets which are under the topmost sheet are also subjected to such a force that works in the direction to move the sheets in the same direction as the topmost sheet. In other words, from the standpoint of separating the topmost sheet from the sheets thereunder, this force works as such a force that interferes with the force (which hereafter may be referred to as “separative force”) which works in the direction to separate the topmost sheet from the sheets thereunder. Therefore, the electrostatic sheet feeding devices structured as disclosed in Japanese Laid-open Patent Application 2012-140224 cannot reliably separate the topmost sheet from the rest and feed it into the main assembly of an image forming apparatus.

In comparison, in the case of the electrostatic sheet feeding devices structured as disclosed in Japanese Laid-open Patent Application 2012-193010, they are structured so that not only the entirety of its electrostatic sheet separating section is moved in an oscillatory manner, but also, the cassette section in which sheets are stored is moved upward or downward, in order to peel the topmost sheet from the sheets thereunder. In addition, in order to prevent the sheet which is remaining electrostatically adhered to the sheet separating section, from being forced to peel away from the electrostatic sheet separating section, by the stiffness of the topmost sheet, the device is structured so that the amount by which its electrostatic sheet separating section is moved in the oscillatory manner, and the amount by which the cassette section is moved upward or downward, are adjustable according to the stiffness of the sheet. However, in the case of the electrostatic sheet feeding devices structured so that the entirety of their electrostatic sheet separating section is moved in the oscillatory manner, and their cassette section, which is substantial in size and weight, is moved upward or downward, large mechanical sounds are generated as the device operates. Moreover, banging noises occur as the electrostatic sheet separating section comes into contact with the topmost sheet (sheets in cassette).

Thus, the primary object of the present invention is to provide a sheet feeding device and an image forming apparatus, which is capable of more reliably separating the topmost sheet of recording medium from the rest, and feed the topmost sheet into the main assembly of the image forming apparatus, and yet, is significantly quieter, than a conventional sheet feeding device and a conventional image forming apparatuses.

According to an aspect of the present invention there is provided a sheet feeding apparatus comprising a stacking device stacked in g a sheet; a first rotatable member provided above said stacking device; a second rotatable member provided upstream of said first rotatable member with respect to a feeding direction of the sheet; an attraction member, supported by said first rotatable member with a slack and said second rotatable member at a inner surface thereof, for electrically attracting the sheet stacked on said stacking device; a first nipping member cooperative with said first rotatable member to nip said attraction member; a second nipping member cooperative with said second rotatable member to nip said attraction member; a controlling device for shifting said attraction member from a stand-by state in which said attraction member is away from the sheet accommodated in said stacking device to an attraction state in which said attraction member is elastically deformed to surface-contact with the sheet stacked on said stacking device to electrostatically attract the sheet, to a separating state for separating the sheet from a lower sheet by lifting a downstream end of the sheet with respect to the feeding direction, and to a spaced state in which said attraction member spaces the attracted sheet from the lower sheet, said controlling device changing a slackness of said attraction member in the separating state on the basis of a stiffness information of the sheet.

Further features of the present invention will become apparent from the following description of exemplary embodiments with reference to the attached drawings.

### BRIEF DESCRIPTION OF THE DRAWINGS

FIG. 1 is a sectional view of an image forming apparatus equipped with the sheet feeding device in the first embodiment of the present invention, and shows the general structure of the apparatus.

FIG. 2 is a drawing for illustrating the structure of the abovementioned sheet feeding device.

FIGS. 3A, 3B, 3C and 3D illustrate the structure of the electrostatic sheet attracting member and electric power supply section of the abovementioned sheet feeding device.

FIG. 4 is a drawing for illustrating the sheet thickness detecting means with which the abovementioned sheet feeding device is provided.

FIG. 5 is a block diagram of the control system which controls the abovementioned sheet feeding device.

FIGS. 6A, 6B, 6C, 6D, 6E and 6F illustrate the sheet feeding operation of the abovementioned electrostatic sheet feeding section.

FIG. 7 is a timing chart of the sheet feeding operation of the abovementioned electrostatic sheet feeding section.

FIG. 8 is a drawing for illustrating the mechanism which causes the topmost sheet to separate from the sheets thereunder as the topmost sheet is moved out of the sheet storage by the abovementioned electrostatic sheet feeding section.

FIG. 9 is a flowchart of the operation in which the sheet feeding device is changed in the sheet separation location by the sheet separation controlling section with which the above described sheet feeding device is provided.

FIG. 10 is a timing chart which shows the timing with which the driving means of the above described electrostatic sheet separating section are changed in their conveyance speed.

FIGS. 11A and 11B illustrate the change which occurs to the amount of the slack of the electrostatic sheet attracting member, as the electrostatic sheet attracting member is changed in the position of its sheet separation location.

FIG. 12 is a drawing for illustrating the table stored in the abovementioned sheet separation controlling section.

FIG. 13 is a flowchart of the operation carried out by the abovementioned sheet separation controlling section to change the above described electrostatic sheet attracting member in the sheet separation location.

FIG. 14 is a drawing for illustrating the structure of the sheet feeding device in the second embodiment of the present invention.

FIG. 15 is a drawing for illustrating the structure of the shape regulating member with which the abovementioned sheet feeding device is provided.

FIG. 16 is a block diagram of the control system which controls the abovementioned sheet feeding device.

FIG. 17 is a flowchart of the operation carried out by the sheet separation controlling section, with which the abovementioned sheet feeding device is provided, to change the electrostatic sheet feeding member in the sheet separation location.

FIGS. 18A and 18B illustrate the change which occurs to the sheet separation location of the electrostatic sheet attracting member as the abovementioned shape regulating member is changed in position.

FIGS. 19A, 19B and 19C illustrate the relationship between the angle (attitude) of the abovementioned shape regulating member, and the sheet separation location of the electrostatic sheet attracting member.

FIG. 20 is a drawing for illustrating the table stored in the abovementioned sheet separation controlling section.

FIG. 21 is a block diagram of the control system of the sheet feeding device in the third embodiment of the present invention.

FIG. 22 is a flowchart of the operation carried out by the sheet separation controlling section with which the above-mentioned sheet feeding device, to change the electrostatic sheet attracting member in the sheet separation location.

FIG. 23 is a drawing for illustrating the relationship among the angle (attitude) of the abovementioned shape regulating member, amount of difference in conveyance speed between the first and second driving means, and sheet separation location of the electrostatic sheet attracting member.

FIGS. 24A and 24B show the tables stored in the abovementioned sheet separation controlling section.

FIG. 25 is a block diagram of the control system of the sheet feeding device in the fourth embodiment of the present invention.

FIG. 26 is a drawing for illustrating the table stored in the abovementioned sheet separation controlling section.

### DESCRIPTION OF THE EMBODIMENTS

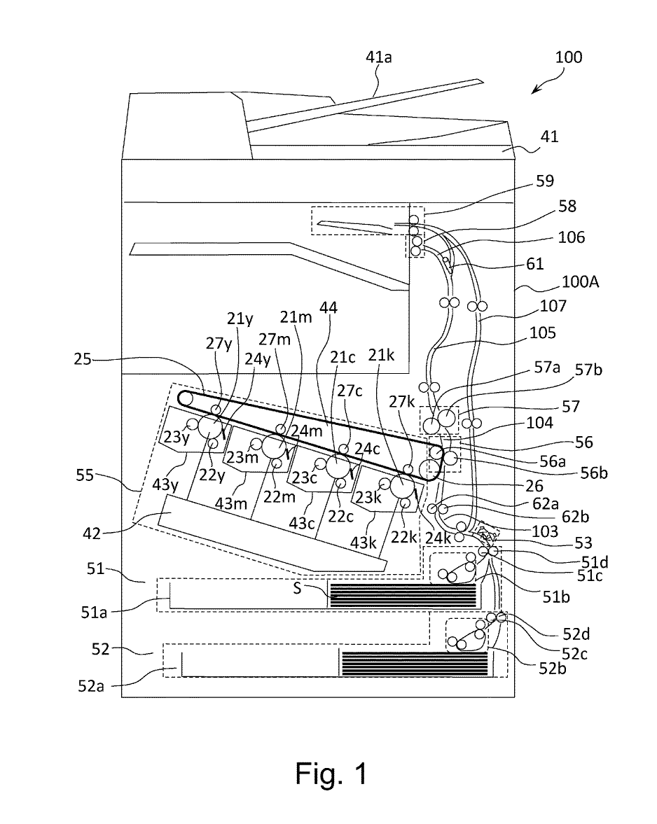

Hereinafter, some of preferred embodiments of the present invention are described in detail with reference to appended drawings. FIG. 1 is a drawing which shows the general structure of the image forming apparatus equipped with the sheet feeding device in the first preferred embodiment of the present invention.

Referring to FIG. 1, a referential code 100 stands for an image forming apparatus, and a referential code 100A stands for the main assembly of the image forming apparatus 100 (which hereafter will be referred to simply as apparatus main assembly 100A). The apparatus main assembly 100A is provided with an image reading section 41, which is disposed in the top portion of the apparatus main assembly 100A. The image reading section 41 has a platen glass as an original placement plate, an image sensor which projects a beam of light upon an original placed on the platen glass, and converts the beam of light reflected by the original into digital signals, etc. Incidentally, an original from which an image is read is conveyed onto the platen glass by an automatic original feeding device 41a. Further, the apparatus main assembly 100A is provided with an image forming section 55, sheet feeding sections 51 and 52 which feed a sheet S of recording medium to the image forming section 55, a sheet reversing section 59 which turns a sheet S of recording medium upside down and sends the sheet S to the image forming section 55.

The image forming section 55 is equipped with an exposing unit 42, and four process cartridges 43 (43y, 43m, 43c and 43k) which form yellow (Y), magenta (M), cyan (C) and black (Bk) toner images, respectively. Further, the image forming section 55 is equipped with an intermediary transfer unit 44, a secondary transferring section 56, and fixing section 57, which are on the top side of the four process cartridges 43.

Here, each of the four process cartridges 43 has a photosensitive drum 21 (21y, 21m, 21c and 21k), a charge roller 22 (22y, 22m, 22c and 22k), and a development roller 23 (23y, 23m, 23c and 23k). Moreover, each process cartridge 43 has a drum cleaning blade 24 (24y, 24m, 24c and 24k).

The intermediary transfer unit 44 has an intermediary transfer belt 25 which is suspended and kept tensioned by a belt driving roller 26, a belt backing roller 56, and primary transfer rollers 27 (27y, 23m, 23c and 23k) which are in contact with the intermediary transfer belt 25 in such a manner that they oppose corresponding photosensitive drums 21 (21y, 21m, 21c and 21k), respectively. Moreover, as positive transfer bias is applied to the intermediary transfer belt 25 by the primary transfer roller 27, the toner images on the photosensitive drums 21, which are positive in polarity, are sequentially transferred in layers onto the intermediary transfer belt 25. Consequently, a full-color image is formed on the intermediary transfer belt 25, as will be described later.

The secondary transferring section 56 comprises an inward secondary transfer roller 56a, an outward secondary transfer roller 56b which is kept pressed against the inward secondary transfer roller 56a, with the placement of the intermediary transfer belt 25 between the two secondary transfer rollers 56a and 56b. Further, the full-color image formed on the intermediary transfer belt 25 is transferred onto a sheet S of recording medium by the application of the secondary transfer bias, which is positive in polarity, to the outward secondary transfer roller 56a, as will be described later.

The fixing section 57 has a fixation roller 57a and a sheet backing roller 57b. As a sheet S of recording medium is conveyed between the fixation roller 57a and sheet backing roller 57b, remaining pinched by the two rollers 57a and 57b, the toner image on the sheet S is subjected to pressure and heat, whereby the toner image is fixed to the sheet S. The sheet feeding devices 51 and 52 are provided with a pair of cassettes 51a and 52a which are means for storing sheets S, and a pair of electrostatic sheet separating-feeding sections 51b and 52b which have a function of feeding one by one the sheets stored in cassettes 51a and 52a, while keeping the sheet S electrostatically adhered thereto.

By the way, referring to FIG. 1, a referential code 103 stands for a pre-transfer sheet conveyance passage which guides each sheet S from the sheet feeding devices 51 or 52 to the secondary transferring section 56 as the sheet S is fed into the apparatus main assembly 100A from the cassette 51a or 52a. A referential code 104 stands for a pre-fixation sheet conveyance passage which guides the sheet S from the secondary transferring section 56 to the fixing section 57 as the sheet S is conveyed to the secondary transferring section 56. A referential code 105 stands for a post-fixation sheet conveyance passage which guides the sheet S from the fixing section 57 to a switching member 61 as the sheet S comes out of the fixing section 57. A referential code 106 stands for a sheet discharge passage which guides the sheet S from the switching member 61 to a sheet discharging section 58 as the sheet S is conveyed to the switching member 61. A referential code 107 stands for a reconveyance passage which conveys the sheet S from a sheet reversing section 59 to convey the sheet S to the image forming section 55 for the second time to form an image on the opposite surface of the sheet S from the surface on which an image was formed for the first time by the image forming section 55.

Next, the image forming operation of the image forming apparatus 100 structured as described above is described. As the image forming operation is started, first, the exposing unit 42 projects a beam of laser light toward the peripheral surface of the photosensitive drum 21 while modulating the beam according to the image information received from an unshown personal computer or the like. At this point in time, the peripheral surface of photosensitive drum 21 has been uniformly charged to preset polarity and potential level by the charge roller 22. Thus, as the exposing unit projects the beam of laser light as described above, the points of peripheral surface of the photosensitive drum 21, which were exposed to the beam of laser light, attenuate in potential. Consequently, an electrostatic latent image is effected on the peripheral surface of the photosensitive drum 21.

Thereafter, the electrostatic latent image is developed by the yellow (Y), magenta (M), cyan (C) or black (Bk) toner supplied thereto by the development roller 23, into a visible image, or an image formed of toner, which hereafter will be referred to as toner image. The four toner images, different in color, which were formed through the above described processes are sequentially transferred onto the intermediary transfer belt 25 by the primary transfer bias applied to each of the four primary transfer rollers 27. Consequently, a full-color toner image is effected on the intermediary transfer belt 25.

Meanwhile, the sheet feeding devices 51 or 52 separates only one of the sheets in the cassettes 51a or 52a, from the multiple sheets S in the cassettes 51a or 52a, and feeds the separated sheet S into the apparatus main assembly 100A, with the use of its electrostatic sheet separating-feeding sections 51b or 52b. Thereafter, the sheet S reaches a pair of sheet plucking rollers 51c and 51d, or a pair of sheet plucking rollers 52c and 52d. After being pinched by the pair of plucking rollers 51c and 51d, or pair of plucking rollers 52c and 52d, it is conveyed through a sheet thickness detecting means 53, in which the thickness of the sheet S is detected. Then, it is sent into the pre-secondary transfer conveyance passage 103, in which it comes into contact with a pair of registration rollers 62a and 62b which are remaining stationary. Thus, the sheet S is adjusted in the position of its leading edge.

Next, the pair of registration rollers 62a and 62b begin to be driven with such a timing that the arrival of the full-color toner image on the intermediary transfer belt 25 at the secondary transferring section 56 coincides with that of the sheet S. Thus, the sheet S is conveyed to the secondary transferring section 56, in which the full-color toner image on the intermediary transfer belt 25 is transferred onto the sheet S; the four monochromatic toner images, different in color, are transferred together, onto the sheet S.

After the transfer of the full-color toner image onto the sheet S, the sheet S is conveyed to the fixing section 57, in which it is subjected to heat and pressure. Thus, the four toners (toner images), different in color, melt and mix. Consequently, the four toners (toner images) become fixed as a full-color image to the sheet S. Thereafter, the sheet S is discharged from the apparatus main assembly 100A by the sheet discharging section 58, which is on the downstream side of the fixing section 57. By the way, in a case where an image is formed on both surfaces of the sheet S, the sheet S is reversed in its conveyance direction, in the sheet reversing section 59, and then, is conveyed to the image forming section 55 for the second time.

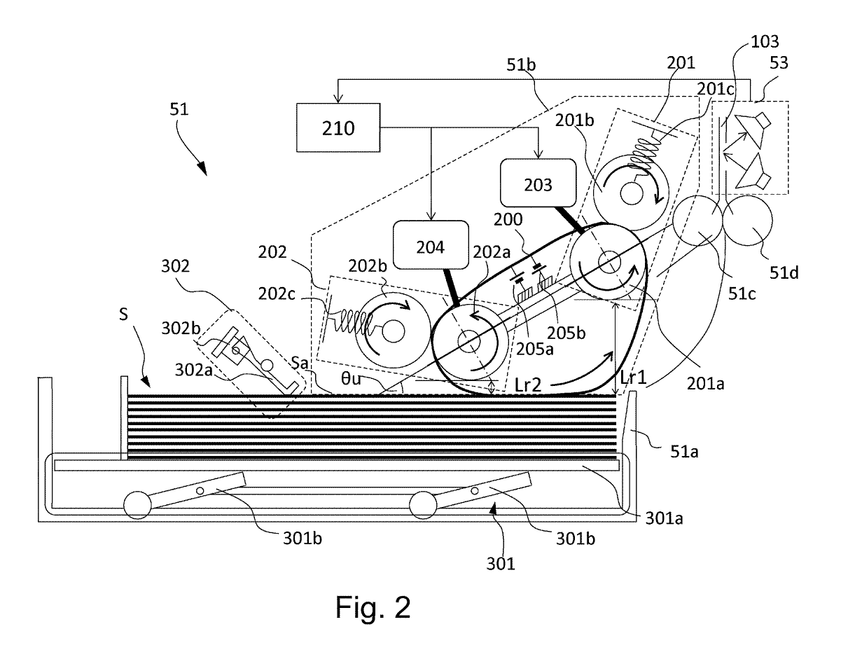

Next, referring to FIG. 2, the sheet feeding device in this embodiment is described about its structure. As described above, the sheet feeding device is equipped with an electrostatic sheet separating-feeding section 51b, which feeds one by one the sheets S in the cassette 51a or 52a by separating the topmost sheets in the cassette 51a or 52a from the rest, by causing the sheet S to adhere thereto with the use of static electricity. Further, the sheet feeding device 51 is also equipped with the pair of sheet plucking rollers 51c and 51d. As the sheet S is conveyed to the pair of plucking rollers 51c and 51d, the rollers 51c and 51d pinch the sheet S, and convey the sheet S further into the apparatus main assembly 100A.

The cassette 51a is a means in which multiple sheets S of recording medium are stored in layers. It can be moved upward or downward. It has a lifting-lowering means 301 for moving upward or downward a middle plate 301a, on which sheets S are placed in layers, and a sheet position detecting means 302 for detecting the vertical position of the top surface of the topmost sheet S on the middle plate 301a. The lifting-lowering means 301 is equipped with a pair of lifters 301b, which is under the middle plate 301a and is rotationally movable. The vertical position of the topmost sheet S on the middle plate 301a can be changed by changing the rotational angle of the lifters 301b.

The electrostatic sheet separating-feeding section 51b is provided with the first pair of pinching-conveying rollers 201, the second pair of pinching-conveying rollers 202, and a flexible and endless sheet attracting member 200, which remains pinched by the first pair of pinching-conveying rollers 201, and the second pair of pinching-conveying rollers 202. The electrostatic sheet separating-feeding section 52b with which the sheet feeding device 52 is provided is the same in structure as the electrostatic sheet separating-feeding section 51b of the sheet feeding device 51. Thus, it is not described here.

By the way, referring to FIG. 2, a referential code 302 stands for a sheet surface position detecting means for detecting the vertical position of the top surface of the topmost sheet S on the middle plate 301a. This sheet surface position detecting means 302 is disposed above the middle plate 301a. It comprises a sensor flag 302a and a photosensor 302b. The sensor flag 302a is rotatably supported by an unshown supporting section. It is disposed so that one end of it is placeable in contact with the top surface of the topmost sheet S on the middle plate 301a, and the other end is placeable to optically shield the photosensor 302b.

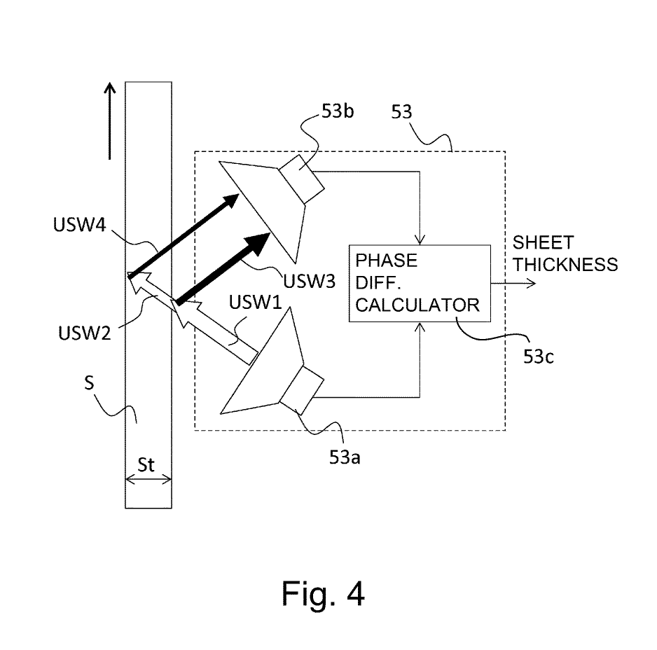

The sheet feeding device 51 is structured so that as the top surface of the topmost sheet Sa moves to a preset height, the sensor flag 302a rotates, whereby the photosensor 302b is optically blocked. A control section 70, shown in FIG. 4, which will be described hereinafter, detects the position of the top surface of the topmost sheet Sa, by detecting the state of optical blockage of the photosensor 302b. Further, the controlling section 70 controls the middle plate 301a in vertical position by controlling the movement of the lifting-lowering means 301 so that the top surface of the topmost sheet Sa is always detected by the sheet surface position detecting means 302, and remains roughly the same in vertical position.

Thus, a gap Lr1, which is the distance between the first pair of pinching-conveying rollers 201 and the top surface of the topmost sheet Sa, remains roughly the same, and so does a gap Lr2, which is the distance between the second pair of pinching-conveying rollers 202 and the top surface of the topmost sheet Sa. By the way, in this embodiment, the gap Lr1 between the pair of the first pinching-conveying rollers 201 and the vertical position of the top surface of the topmost sheet Sa is wider than the gap Lr2 between the pair of the second pinching-conveying rollers 202 and the vertical position of the top surface of the topmost sheet Sa. That is, Lr1≧Lr2.

In terms of the sheet conveyance direction, the pair of first pinching-conveying rollers 201 are disposed on the downstream side of the pair of second pinching-conveying rollers 202. In terms of the vertical direction, the former is disposed on the top side of the latter. Further, the pair of first pinching-conveying rollers 201 is made up of an inward first pinching-conveying roller 201a (first rotational member) and an outward first pinching-conveying roller 201b (first pinching member). The inward first pinching-conveying roller 201a is disposed on the inward side of the loop which the sheet attracting member 200 forms. It is rotatably supported by an unshown shaft supporting member, which is fixed in position. To the inward first pinching-conveying roller 201a, the driving force from the first driving means 203 is transmitted through an unshown driving force transmitting means.

The outward first pinching-conveying roller 201b, which is rotated by the rotational movement of the sheet attracting member 200, is disposed outside the loop which the sheet attracting member 200 forms, with the placement of the sheet attracting member 200, which is in the form of an endless belt, between the outward first pinching-conveying roller 201b and inward first pinching-conveying roller 201a. To the abovementioned unshown shaft supporting member, a pair of first compression springs 201c are connected. Thus, the outward first pinching-conveying roller 201b is kept pressed toward the rotational axis of the inward first pinching-conveying roller 201a, by the first compression springs 201c, whereby the sheet attracting member 200 remains pinched between the outward first pinching-conveying roller 201b and inward first pinching-conveying roller 201a.

The pair of second pinching-conveying rollers 202 is made up of an inward second pinching-conveying roller 202a (second rotational member) and an outward second pinching-conveying roller 202b (second pinching member). The inward second pinching-conveying roller 202a is rotationally supported by an unshown shaft supporting member which is fixed in position. To the inward second pinching-conveying roller 202a, driving force is transmitted from the second driving means 204 through an unshown driving force transmitting means.

The outward second pinching-conveying roller 201b, which is rotated by the rotational movement of the sheet attracting member 200, is disposed outside the loop which the sheet attracting member 200 forms, with the placement of the sheet attracting member 200, which is in the form of an endless belt, between the outward second pinching-conveying roller 202b and inward second pinching-conveying roller 202a. To the abovementioned unshown shaft supporting member, a pair of second compression springs 202c are connected. Thus, the outward second pinching-conveying roller 202b is kept pressed toward the rotational axis of the inward second pinching-conveying roller 202a, by the second compression springs 202c, whereby the sheet attracting member 200 remains pinched between the outward second pinching-conveying roller 202b and inward second pinching-conveying roller 202a.

In this embodiment, the sheet attracting member 200 which is in the form of an endless belt is supported by its inward surface, by two rotational members, that is, the inward first pinching-conveying roller 201a and inward second pinching-conveying roller 202a. The circumferential length of this sheet attracting member 200 is greater than the sum of twice the distance between the rotational axis of the inward first pinching-conveying roller 201a and the rotational axis of the inward second pinching-conveying roller 202a, half of the circumferential length of the roller 201a, and half of the circumferential length of the roller 202a.

That is, the circumferential length of the sheet attracting member 200 is greater than the circumferential length of the theoretically shortest sheet attracting member (200) which can be fitted around the combination of the inward first and second pinching-conveying rollers 201a and 202a. In other words, the sheet attracting member 200 is made long enough to loosely fit (with presence of preset amount of slack) around the combination of the two rollers 201a and 202a. With the sheet attracting member 200 given the above described circumferential length, the sheet attracting member 200 is allowed to slacken downward while it is rotationally moved by the rotation of the inward first pinching-conveying roller 201a and the rotation of the inward second pinching-conveying roller 202a. Thus, even though there are the gap Lr1 between the inward first pinching-conveying roller 201a and the topmost sheets Sa on the middle plate 301a, and the gap Lr2 between the inward second pinching-conveying roller 202a and the topmost sheet S on the middle plate 301a, it is possible for the sheet attracting member 200 to contact the topmost sheet Sa.

In this embodiment, in order to prevent sheets S from rubbing against each other while the topmost sheet Sa is conveyed by the sheet attracting member 200 which is electrostatically holding the topmost sheet Sa, the sheet feeding device 51 is structured so that after the attraction of the topmost sheet Sa to the sheet attracting member 200 with the use of static electricity, the sheet attracting member 200 is moved upward while being elastically deformed. That is, the sheet attracting member 200 separates the topmost sheet Sa from the rest of the sheets S on the middle plate 301a by being elastically deformed so that its bottom portion is moved upward.

In this embodiment, the electrostatic sheet separating-feeding section 51b is disposed so that the line connecting the axial line of the inward first pinching-conveying roller 201a and the axial line of the inward second pinching-conveying roller 202a in FIG. 2 holds an angle of θu relative to the sheet S on the middle plate 301a. Further, as described previously, the relationship between the gap Lr1 between the inward first pinching-conveying roller 201a and the top surface of the topmost sheet Sa and the gap Lr2 between the inward second pinching-conveying roller 202a and the top surface of the topmost sheet Sa is: Lr1≧Lr2. Thus, it is possible for the electrostatic sheet separating-feeding section 51b to electrostatically hold the topmost sheet Sa in a manner of upwardly peeling the sheet Sa away from the rest. Therefore, the sheet feeding device 51 in this embodiment can generate such separating force that can proficiently separate the topmost sheet Sa from the rest.

Also in this embodiment, the length of the sheet attracting member 200 is made to be such that the area of contact between the sheet attracting member 200 and the topmost sheet Sa becomes the appropriate size for generating a proper amount of electrostatic force necessary to separate the topmost sheet Sa from the rest. Further, the sheet attracting member 200 is in electrical connection to a positive voltage supplying means 205a from which positive voltage is supplied to the sheet attracting member 200, and a negative voltage supplying means 205b from which negative voltage is supplied to the sheet attracting member 200. It is by a combination of the positive voltage supplying means 205a (first electric power source), and the negative voltage supplying means 205b (second electric power source) that the electrostatic force for attracting the sheet S is generated in the sheet attracting member 200.

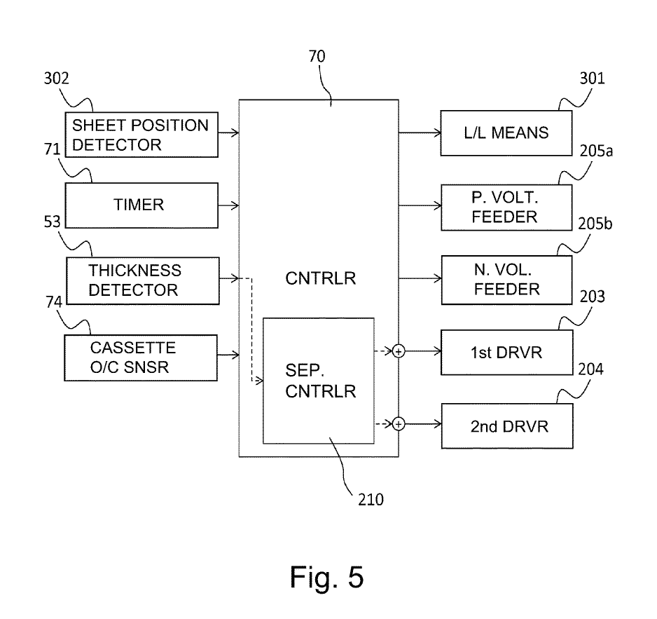

The first and second driving means 203 and 204 are in connection to a sheet separation control section 210 in the controlling section 70 shown in FIG. 5. As the first and second driving means 203 and 204 receive a speed control command pulse sequence, which is transmitted from the sheet separation controlling section 210 according to the type of the sheet S, they drive the inward first pinching-conveying roller 201a and inward second pinching-conveying roller 202a, respectively. Thus, the topmost sheet Sa is separated from the rest in the most appropriate manner to the topmost sheet Sa. That is, the topmost sheet Sa is separated from the rest in such a manner that is most accommodating to the topmost sheet Sa. The detailed description of this operation will be given later.

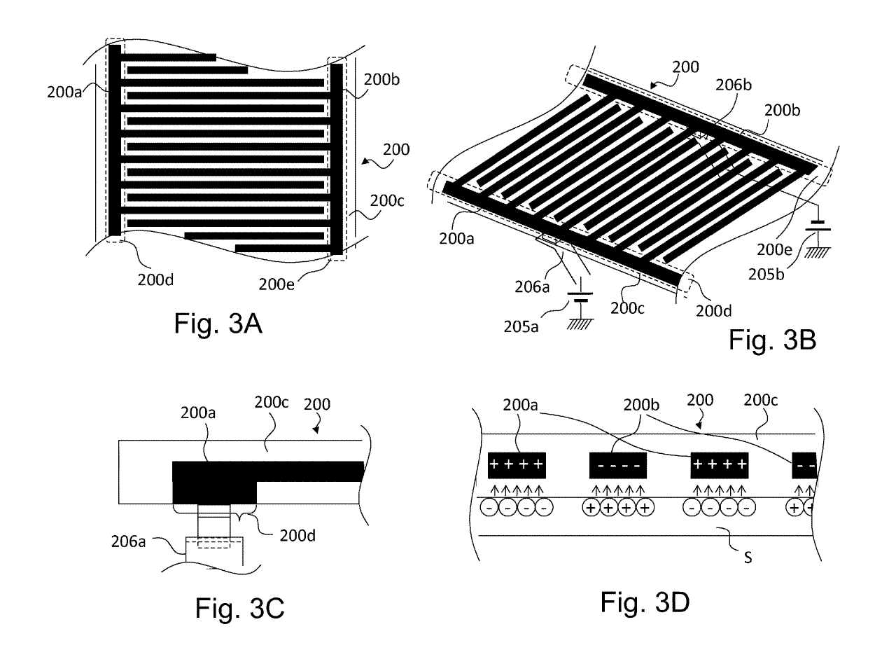

Next, referring to FIGS. 3A, 3B, 3C and 3D, the detailed structure of the sheet attracting member 200, and the principle based on which the force which attracts the sheet S and keeps the sheet S adhered to the sheet attracting member 200 are described. By the way, FIG. 3A is a drawing of the sheet attracting surface of the sheet attracting member 200, and FIG. 3B is a perspective view of the sheet attracting member 200. FIG. 3C is a sectional view of the electric power supply section of the sheet attracting member 200. FIG. 3D is a drawing for conceptually showing the electrostatic attraction between the sheet attracting member 200 and sheet S.

Referring to FIGS. 3A, 3B, 3C and 3D, the sheet attracting member 200 has a substrative layer 200c, a positive electrode 200a (first electrode), and a negative electrode 200b (second electrode). Both the positive and negative electrodes 200a and 200b are in the form of a comb, and are embedded in the substrative layer 200c in such a manner that the teeth of the positive electrode 200a and the teeth of the negative electrode 200b are alternately positioned in terms of the lengthwise direction of the sheet attracting member 200. Incidentally, in this embodiment, the material for the substrative layer 200c is a dielectric substance, more specifically, polyamide, which is no less than 108 Ω·cm in volume resistivity. The thickness of the substrative layer 200c is roughly 100 μm. The material for the positive and negative electrodes 200a and 200b are a dielectric substance which is no more than 105 Ω·cm in volume resistivity. It is copper plate which is roughly 10 μm in thickness.

Also in this embodiment, as will be described later, the material for the sheet attracting member 200 is selected to provide the sheet attracting member 200 with a proper amount of elasticity, and also, the sheet attracting member 200 is adjustable in thickness, etc., in order to allow the sheet attracting member 200 to slack downward in such a manner that when the sheet attracting member 200 is made to contact the topmost sheet Sa, it deforms in such a shape that its cross-section becomes barrel-shaped. The inward surface of the sheet attracting member 200, which faces the peripheral surface of the inward first pinching-conveying roller 202a and the peripheral surface of the inward second pinching-conveying roller 202b, is provided with a pair of electrode exposure areas 200d and 200e where the base portion of the comb-shaped positive electrode and the base portion of the comb-shaped negative electrode are exposed, respectively. The exposed portion 200d of the positive electrode is in contact with the positive contact point 206a which is in contact with the aforementioned positive voltage supplying means 205a, whereas the exposed portion 200e of the negative electrode 200b is in contact with the negative contact point 206b which is in contact with the aforementioned negative voltage supplying means 205b.

In this embodiment, positive voltage which is roughly +1 kV is applied to the positive electrode 200a, and negative voltage which is roughly −1 kV is applied to the negative electrode 200b. The positive and negative contact points 206a and 206b, respectively, are made up of a piece of metallic plate and a carbon brush crimped to one end of the piece of metallic plate. The carbon brush of the positive contact point 206a is in contact with the exposed portion 200d of the positive electrode 200a, and the carbon brush of the negative point 206b is in contact with the exposed portion 200e of the negative electrode 200b. Since the positive and negative electrodes 206a and 206b are provided with elasticity, they can remain in contact with the sheet attracting member 200 even while the sheet attracting member 200 continually changes in shape in terms of cross section. Therefore, it is ensured that the sheet attracting member 200 is continuously supplied with electric power regardless of the change in the shape of the sheet attracting member 200.

Next, referring to FIG. 3D, as the positive and negative voltages are applied to the positive and negative electrodes 200a and 200b, respectively, a nonuniform electric field is generated in the adjacencies of the surfaces of the sheet attracting member 200. As the sheet attracting member 200 having the nonuniform electric field in the adjacencies of its surfaces is moved close to the sheet S, a dielectric polarization occurs to the surface layer of the sheet S, which is dielectric. Thus, the sheet attracting member 200 and sheet S are attracted to each other (Maxwell stress).

In this embodiment, the image forming apparatus 100 is provided with a sheet thickness detecting means 35, which is a stiffness detecting means for detecting the stiffness of the sheet S by detecting the thickness of the sheet S. Referring to FIG. 2, the sheet thickness detecting means 53 is disposed in the pre-secondary transfer conveyance passage 103 which guides the sheet S from the sheet feeding device 51 to the secondary transferring section 56. The sheet thickness detecting means 53 detects the thickness of the sheet S with the use of ultrasonic waves. Referring to FIG. 4, the sheet thickness detecting means 53 has an ultrasonic wave sending element 53a, an ultrasonic wave receiving element 35b, and a phase difference computation circuit 53c.

From the ultrasonic wave sending element 53a, ultrasonic wave USW1 is sent toward the surface of the sheet S. As the ultrasonic wave SW1 reaches the surface of the sheet S, it is separated into a component USW2 which transmits through the sheet S, and a component USW3 which is reflected by the sheet S. The reflected USW3 is received by an ultrasonic wave receiving element 53b. On the other hand, the ultrasonic wave USW2 having transmitted through the sheet S is reflected by the back surface of the sheet S, and is received as a reflected ultrasonic wave USW4 by the ultrasonic wave receiving element 53b.

The ultrasonic wave USW3 and ultrasonic wave USW4 are different in the distance they travel from the ultrasonic wave sending element 53 to reach the ultrasonic wave receiving element 53b. Therefore, they become different in the timing with which they are received by the ultrasonic wave receiving element 53b. That is, there occurs a difference Δt in phase between the former and latter. More concretely, they are different from each other by roughly twice the thickness St of the sheet S, in terms of the distance they travel. Therefore, the thickness St of the sheet S can be obtained by measuring the amount of difference Δt in phase with the use of the phase difference computation circuit 53c (St=c×Δt/2, wherein c stands for speed of sound).

In this embodiment, the sheet thickness detecting means 53 is such a means that uses a sheet thickness detecting method which uses ultrasonic waves. However, this embodiment is not intended to limit the present invention in scope. For example, a method which detecting the sheet thickness St by projecting a beam of light upon the sheet S and detecting the amount by which the beam of light transmits through the sheet S. Further, some of conventional image forming apparatuses are provided with a means for detecting, or setting, the surface properties and thickness of the sheet S in order to change the secondary transfer condition and/or image fixation condition according to the type of the sheet S. In the case of such image forming apparatuses, the information obtained by the detecting means, or the information set by the setting means may be used in place of the sheet thickness St detected by the sheet thickness detecting means 53. For example, instead of providing the image forming apparatus 100 with the above-described sensors, the information about the sheet type, which is set (inputted) by a user when a printing job is inputted by the user, may be used.

FIG. 5 is a block diagram of the control system of the sheet feeding device 51 in this embodiment. Referring to FIG. 5, a referential code 70 stands for a controlling section. The controlling section 70 is in connection to the positive voltage supplying means 205a, negative voltage supplying means 205b, sheet surface elevation detecting means, sheet thickness detecting means, timer 71, cassette opening-closing detection sensor 74, etc.

The controlling section 70 contains a sheet separation controlling section 210 as a subordinate system, which is in connection to the first and second driving means 203 and 204. Further, the sheet separation controlling section 210 has an unshown internal storage area, in which a table Mt1 for setting the sheet separation condition based on the sheet thickness detected by the sheet thickness detecting means 53 is stored. Moreover, the sheet separation controlling section 210 transmits the speed setting command pulse sequence, which are set according to the sheet thickness St, and the sheet separation condition which is set with reference to the table Mt1, to the first and second driving means 203 and 204. By the way, the method for controlling this sheet separation controlling section 210 will be described later in detail.

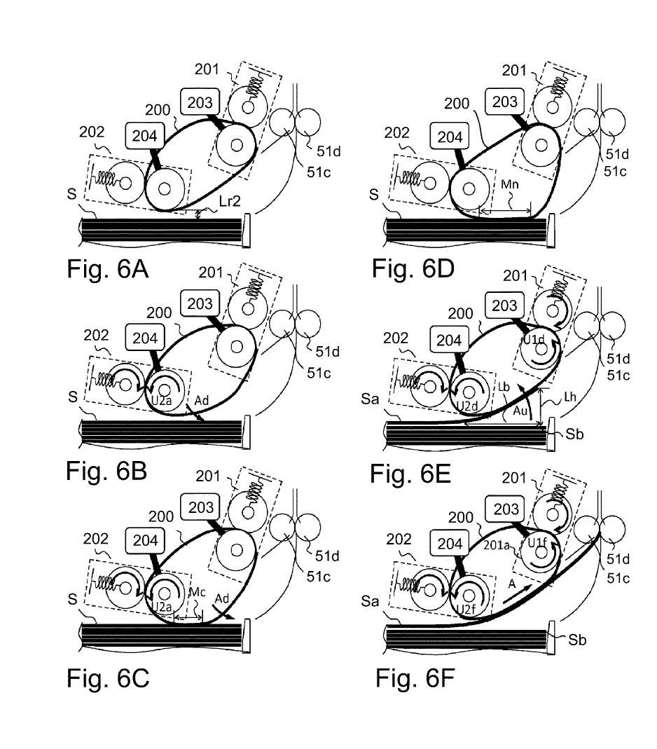

Next, referring to FIGS. 6A, 6B, 6C, 6D, 6E and 6F, the sheet separating-feeding operation carried out by the electrostatic sheet separating-feeding section 51b is described. By the way, these Figures are schematic drawing which chronologically shows the steps through which the sheet S is fed into the apparatus main assembly 100A by the electrostatic separating-feeding section 51b. The sheet feeding operation is made up of six processes, which are an initialing process, an approaching process, a contact area increasing process, an electrostatically attracting process, a separating process, and a feeding process, stating in chronological order. Next, these processes are described in the listed order. By the way, in this embodiment, in each of the abovementioned processes, the sheet attracting member 200 remains in contact with both the positive voltage supplying means 205a and negative voltage supplying means 205b. Therefore, there is always an electric field in the adjacencies of the sheet attracting member 200.

The initialing process shown in FIG. 6A is such a process that places the sheet attracting member 200 in the sheet feeding operation starting position (puts member 200 on standby). In this embodiment, in this initializing process, the controlling section 70 positions the sheet attracting member 200 so that the preset gap Lr2 is provided between the sheet attracting member 200 and the topmost sheet Sa. Then, it stops the first and second driving means 203 and 204.

The approaching process shown in FIG. 6B is such a process that causes the sheet attracting side of the sheet attracting member 200 to approach the topmost sheet Sa by causing the sheet attracting member 200 to deform downward to give the sheet attracting member 200 a barrel-like cross-section (moves slackened portion downward). In this process, the controlling section 70 rotates the pair of the second pinching-conveying roller 201 in the direction indicated by an arrow mark at a rotational speed of U2a with the use of the second driving means 204. However, the controlling section 70 keeps the pair of first pinching-conveying rollers 201 stationary, or rotates the pair of first pinching-conveying rollers 201 at a slower rotational speed than the rotational speed U2a, with the use of the first driving means 203. Thus, the sheet attracting member 200 is moved in the direction indicated by an arrow mark Ad. Consequently, the sheet attracting member 200 becomes barrel-shaped in cross-section. Because the sheet attracting member 200 is deformed in a shape of a barrel, the sheet attracting surface of the sheet attracting member 200 comes into contact with the topmost sheet Sa.

The contact area increasing process shown in FIG. 6C is such a process that causes the sheet attracting member 200 to continue to move toward the topmost sheet Sa to increase in size the area Mc of contact between the sheet attracting surface of the sheet attracting member 200, which is in the position into which it has just been moved to electrostatically attract the sheet Sa, and the topmost sheet Sa. In this process, the controlling section 70 rotates the pair of second pinching-conveying rollers 202 in the direction indicated by an arrow at the rotational speed of U2a with the use of the second driving means 204 as in the approaching process. However, it rotates the pair of first pinching-conveying rollers 201 with the use of first driving means 203 at a speed which is slower than the rotational speed U2a. Thus, the sheet attracting member 200 is moved in the direction indicated by the arrow mark Ad. Consequently the area Mc of contact increases in size.

The controlling section 70 continues the above described process of increasing in size the area Mc of contact, until the area Mc of contact becomes equal in size to a preset size Mn. Here, the image forming apparatus 100 may be provided with a means for directly detecting the size of the area Mc of contact. In this embodiment, however, the size of the area Mc of contact is estimated based on the difference between the amount by which the sheet attracting member 200 was conveyed by the pair of first pinching-conveying rollers 201, and the amount by which the sheet attracting member 200 was conveyed by the pair of second pinching-conveying roller 202, per unit length of time measured by a timer 71, instead of being directly measured.

The sheet attracting process shown in FIG. 6D is a such a process that causes the topmost sheet Sa to adhere to the sheet attracting member 200 so that the size of the area of contact between the top surface of the topmost sheet Sa and the sheet attracting surface of the sheet attracting member 200 becomes the size Mn. Here, as the topmost sheet Sa and sheet attracting member 200 come into contact with each other, the sheet attracting member 200 and topmost sheet Sa are electrostatically attracted to each other, because electric voltage is being applied to the sheet attracting member 200 through the positive and negative voltage supplying means 205a and 205b, as described above. Thus, the topmost sheet Sa is adhered to the sheet attracting member 200 in such a manner that the size of the area Mc of contact between the sheet attracting member 200 and the topmost sheet Sa becomes Mn. By the way, as the topmost sheet Sa is adhered to the sheet attracting member 200 as described above, the controlling section 70 stops the first and second driving means 203 and 204.

The separating process shown in FIG. 6E is such a process that separates the topmost sheet Sa from a sheet Sb, or the sheet which is immediately below the topmost sheet Sa, while elastically deforming upward the topmost sheet Sa which is remaining adhered to the sheet attracting member 200. In this process, the sheet separation controlling section 210 rotates the pair of first pinching-conveying rollers 201 in the direction indicated by the arrow mark at a rotational speed U1d with use of the first driving means 203.

However, the sheet separation controlling section 210 stops the pair of second pinching-conveying rollers 202, or rotates them at a rotational speed U2d, which is slower than the rotational speed U1d, with the use of the second driving means 204, in order to reduce the sheet attracting member 200 in the amount of slack. Consequently, the sheet attracting member 200 is moved in the direction indicated by an arrow mark Au. Thus, the sheet attracting member 200 deforms the downstream portion, in terms of the sheet conveyance direction, of the topmost sheet Sa by an amount Lb (length of bending) which is the distance between the downstream edge of the topmost sheet Sa and the upstream edge Pb of the area of contact between the sheet attracting member 200 and topmost sheet Sa. That is, the sheet attracting member 200 deforms the topmost sheet Sa in such a manner that the downstream edge of the topmost sheet Sa is lifted by a distance Lh (height of bending) from where it was before it began to be deformed. Thus, the topmost sheet Sa is moved into the position (position of separation) in which it begins to be completely separated from the sheet Sb. In this embodiment, by the way, this position in which the topmost sheet Sa begins to be completely separated from the sheet Sb is altered according to the information about the sheet thickness, that is, the information about the stiffness of the sheet S, detected by the sheet thickness detecting means 53. The detailed description of the alteration of this position is given later.

The feeding process shown in FIG. 6F is such a process that conveys the topmost sheet Sa adhered to the sheet attracting member 200 to the pair of plucking rollers 51c and 51d, that is, the sheet conveying means which is on the immediately downstream side of the sheet feeding device, while keeping the sheet attracting member 200 in the same shape as that in which the sheet attracting member 200 was while it was separating the topmost sheet Sa from the sheet Sb. In this process, the controlling section 70 keeps the rotational speed U1f of the pair of first pinching-conveying rollers 201 roughly the same as the rotational speed U2f of the pair of second pinching-conveying rollers 202. Thus, the sheet attracting member 200 which is electrostatically holding the topmost sheet Sa is rotationally moved, with its sheet attracting portion (bottom portion) remaining in the same shape as it was in the separating process. As a result, the topmost sheet Sa is conveyed in the direction indicated by an arrow mark A while remaining electrostatically adhered to the sheet attracting member 200, with its downstream (leading) edge portion remaining separated from the sheet Sb.

Thereafter, as the leading (downstream) edge of the topmost sheet Sa comes close to the area in which the sheet attracting member 200 is bent in curvature by the inward first pinching-conveying roller 201a, the leading edge of the topmost sheet Sa separates from the sheet attracting member 200. This separation occurs because as the sheet attracting member 200 is bent in a curve by the inward first pinching-conveying roller 201a, the stiffness of the topmost sheet Sa overcomes the electrostatic force generated by the sheet attracting member 200. In other words, in this embodiment, the sheet feeding device 51 is configured so that the electrostatic force (attraction) which occurs to the sheet attracting member 200 is less than the stiffness of the topmost sheet Sa. That is, the sheet attracting member 200 is moved by this feeding process to the position (sheet separation position) where the downstream edge of the topmost sheet Sa begins to separate from the sheet attracting member 200.

After the separation of the leading edge portion of the topmost sheet Sa from the sheet attracting member 200, the distance between the leading edge of the topmost sheet Sa and the sheet Sb continues to increase. However, the trailing edge portion of the topmost sheet Sa remains adhered to the sheet attracting member 200. Thus, even after the separation of the leading edge portion of the topmost sheet Sa from the sheet attracting member 200, the topmost sheet Sa continues to be conveyed by the sheet attracting member 200, and then, it is transferred to the pair of plucking rollers 51c and 51d. Through the above described six processes, only the topmost sheet Sa among the multiple sheets S stored in layers in the cassette 51a is fed into the apparatus main assembly 100A. Thus, the multiple sheets S in the cassette 51a can be consecutively fed into the apparatus main assembly 100A by sequential repetition of these six processes.

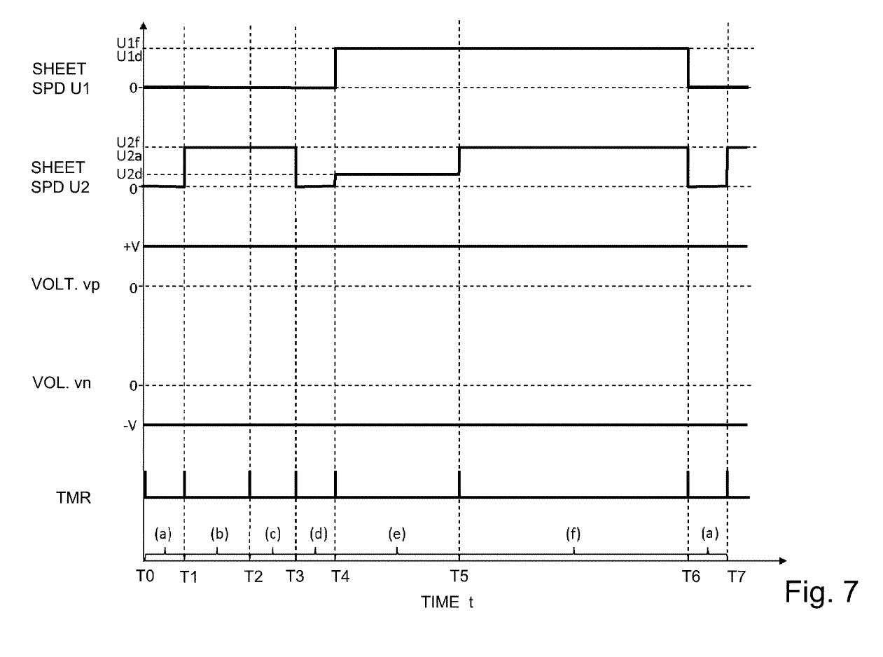

FIG. 7 is a timing chart of the combination of the initializing process, approaching process, contact area increasing process, separating process, and feeding process. In FIG. 7, a referential code U1 stands for the sheet conveyance speed of the pair of first pinching-conveying rollers 201 and a referential code U2 stands for the sheet conveyance speed of the pair of second pinching-conveying rollers 202. A referential code vp stands for the positive voltage supplied from the positive voltage supplying means 205a, and a referential code vn stands for the negative voltage supplied from the negative voltage supplying means 205b.

In FIG. 7, a period from a point T0 in time to a point T1 in time, which has a referential code (a) is the initializing period, in which the sheet conveyance speeds U1 and U2 are set to 0, the voltages vp and vn are set to +V and −V, respectively. In this embodiment, by the way, the voltages vp and vn are set to +V and −V regardless of the sheet type; they are not changed. A period from a point T1 in time to a point T2 in time, which has a referential code (b), is the approaching period, in which the sheet conveyance speed U1 is set to 0 whereas the sheet conveyance speed U2 is set U2a, respectively. The sheet conveyance speed U2a is such a speed that is set based on the productivity or the like properties of the image forming apparatus 100. In this embodiment, it is 200 mm/s (U2a=200 mm/s).

A period from a point T2 in time to a point T3 in time, which has a referential code (c), is the contact area increasing period, in which the sheet conveyance speeds U1 and U2 are kept the same at 0 and U2a, respectively, after the point T1 in time. A period from the point T3 in time to a point T4 in time, which has a referential code (d) is the approaching period, in which both the sheet conveyance speeds U1 and U2 and u2 are set to 0 and 0, respectively. A period from the point T4 in time to a point T5 in time, which has a referential code (e) is the separating period, in which the sheet conveyance speeds U1 and U2 are set to U1d and U2d, respectively. A period from a point T5 in time to a point T6 in time, which has a referential code (f), is the feeding period, in which the sheet conveyance speeds U1 and U2 are set to U1f and U2f, respectively. By the way, speeds U1f and U2f also are set based on the productivity or the like properties of the image forming apparatus 100. In this embodiment, they both are 200 mm/s (U1f=U2f=200 m/s).

A period from a point T6 in time to a point T7 in time, which has a referential code (a) is again the initializing period, in which the sheet feeding device 51 is initialized for the conveyance of the next sheet S. Thereafter, the above described processes are repeated to consecutively feed the sheets S into the apparatus main assembly 100A. In this embodiment, in the initializing process, the first and second driving means 203 and 204 are kept stationary. However, both of the two driving means 203 and 204 may be driven at the same preset speed so that a preset amount of gap is maintained between the sheet attracting member 200 and the topmost sheet Sa.

In the approaching process and contact area increasing process, the sheet attracting member 200 is made to approach the topmost sheet Sa by the difference in sheet conveyance speed between the pair of second pinching-conveying rollers 202 and the pair of first pinching-conveying rollers 201. Thus, the area of contact between the sheet attracting member 200 and topmost sheet Sa is increased in size. However, the area of contact may be increased in size by rotating the first driving means in reverse, while keeping the second driving means stationary, in order to make the sheet attracting member 200 approach the topmost sheet Sa.

Further, in the sheet attracting process, the first and second driving means 203 and 204 are kept stationary. However, they may be rotated as long as the size of the area of contact between the sheet attracting member 200 and the topmost sheet Sa remains to be Mn. Also in this embodiment, in each of the above described processes, the sheet attracting member 200 is kept in contact with the positive voltage supplying means 205a and negative voltage supplying means 205b, being thereby continuously provided with an electric field, that is, the source of the electrostatic force (attraction). However, this embodiment is not intended to limit the present invention in scope. For example, it may be only in the three processes, that is, the sheet attracting process, separating process, and feeding process that the sheet attracting member 200 is kept in contact with the positive voltage supplying means 205a and negative voltage supplying means 205b to enable the sheet attracting member 200 to electrostatically attract the topmost sheet Sa.

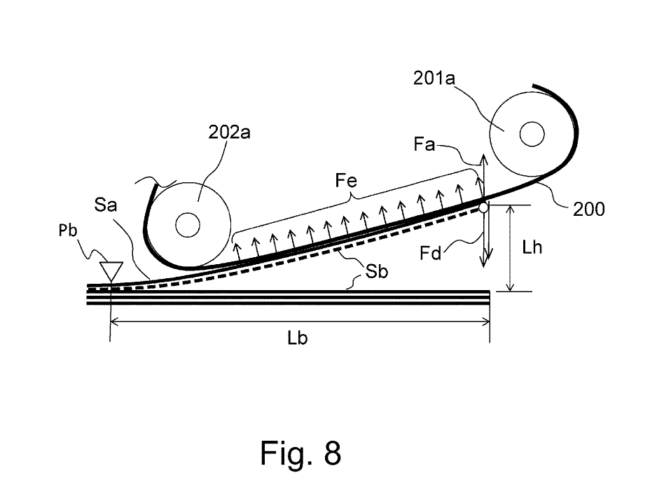

Next, referring to FIG. 8, the mechanism of the sheet separation in this embodiment of the present invention is described. FIG. 8 is a schematic drawing for showing the force which acts on the sheet Sb when the sheet attracting member 200 of the sheet feeding device 51 is in its sheet separating position. As described above, in order to separate the topmost sheet Sa from the sheet Sb, or the sheet which is immediately under the topmost sheet Sa, the sheet feeding device 51 in this embodiment causes its sheet attracting member 200 to attract and hold the topmost sheet Sa with the use of static electricity, and then, elastically deform the sheet attracting member 200 to lift the topmost sheet Sa away from the sheet Sb.

Here, as the topmost sheet Sa is lifted by an electrostatic force Fe, the sheet Sb, which is the second sheet from the top, and from which the topmost sheet Sa is separated, is subjected to an “adhesive” force Fa attributable to the edge burrs, static charge, etc., of the sheets Sa and Sb, and a “separative” force Fd attributable to the stiffness of the sheet Sb. Here the condition that prevents the second sheet Sb from being lifted with the topmost sheet Sa, that is, the condition which allows the topmost sheet Sa to be satisfactorily separated from the second sheet Sb, is expressible in the form of the following mathematical expression (1):

Fd>Fa (1)

Here, the “separative force” Fd of the second sheet Sb can be approximated in the form of the following mathematical expression (2), based on a simple beam model.

Fd=3EI/Lb³×Lh (2)

E and I stand for the module of direct elasticity of sheet Sb, and geometrical moment of inertia, respectively.

All that is necessary for Mathematical Inequity (1) to be viable, that is, all that is necessary for the topmost sheet Sa to be satisfactorily separated from the second sheet Sb, is for Lb (length of bending) or Lh (height of bending) to be set so that the “separative” force Fd which works on the second sheet Sb overcomes the expected amount of the “adhesive” force Fa. However, while the topmost sheet Sa is remaining electrostatically adhered to the sheet attracting member 200, a force which is equal in amount to the “separative” force Fd of the sheet Sb works on the topmost sheet Sa. Here, the “separative” force Fd is such a force that opposes the electrostatic force (“adhesive”) Fe. Thus, if the “separative” force Fd is excessively adjusted, it is possible that the topmost sheet Sa will separate from the sheet attracting member 200, and therefore, the sheet feeding device 51 will misfeed.

According to the research conducted by the inventors of the present invention, in a case where an object to be fed is a sheet S of ordinary recording paper, the stiffness of a sheet S of recording paper, which is equivalent to the product of the module E of direct elasticity of sheet S, and geometrical moment of inertia E of the sheet S, is roughly proportional to the third power of the thickness of the sheet S or the third power of the basis weight of the sheet S. Thus, according to Mathematical Formula (2), the “separative” force Fd of the sheet S is also roughly proportional to the third power of the thickness of the sheet S or the third power of the basis weight of the sheet S. In this embodiment, it is assumed that a sheet S of recording paper, which is an object to be fed into the apparatus main assembly 100A, is a sheet S, which is fed into the apparatus main assembly 100A, is roughly 60-160 g/m² in basis weight. In a case where the basis weight of the sheet S is in a range of 60-160 g/m², the ratio of the maximum amount of the “separative” force Fd of the sheet Sb relative to the minimum amount of the “separative” force Fd of the sheet Sb is roughly 20, based on only the basis weight of the sheet S, which is rather large.

In this embodiment, therefore, the sheet feeding device 51 is configured so that Lb or Lh is adjusted according to the thickness of the sheet S, to keep the “separative” force Fd roughly stable at a value which is greater than the estimated “adhesive” force Fa of the sheet S, and yet, small enough to make it possible for the topmost sheet Sa to be satisfactorily separated from the second sheet Sb. Moreover, in order to keep the “separative” force Fd roughly stable in magnitude at a preset value, the sheet separation controlling section 210 detects the thickness of the sheet S with the use of the sheet thickness detecting means 53, and then, moves the sheet attracting member 200 to the sheet separating position, which is set according to the thickness of the sheet S.

By the way, there is a case where the electrostatic force Fe which enables the sheet attracting member 200 to electrostatically attract and hold the sheet S is large enough to overcome the estimated “adhesive” force Fa, and also, the “separative” force Fd which changes in amount within the basis weight range of the sheet S to be fed. In such a case, it is possible for the topmost sheet Sa to be prevented from peeling itself away from the sheet attracting member 200. Generally speaking, however, from the standpoint of safety and apparatus size, it is not easy to increase the electrostatic force Fe. Thus, the present invention (this embodiment) is superior.

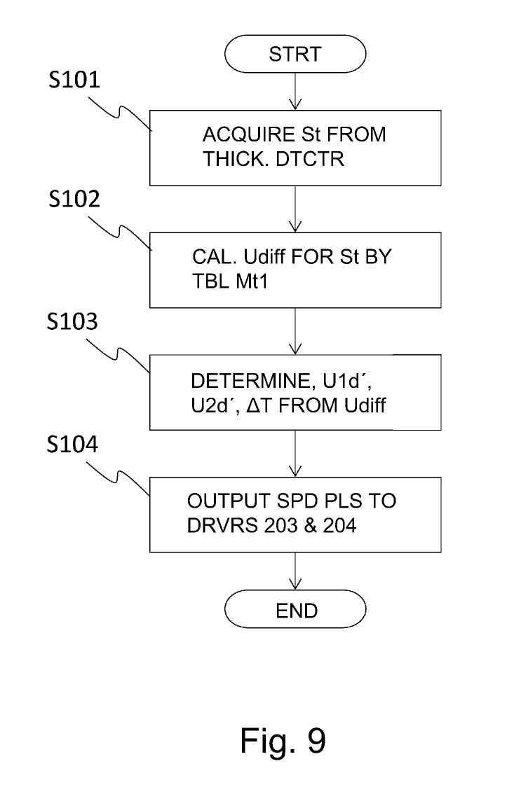

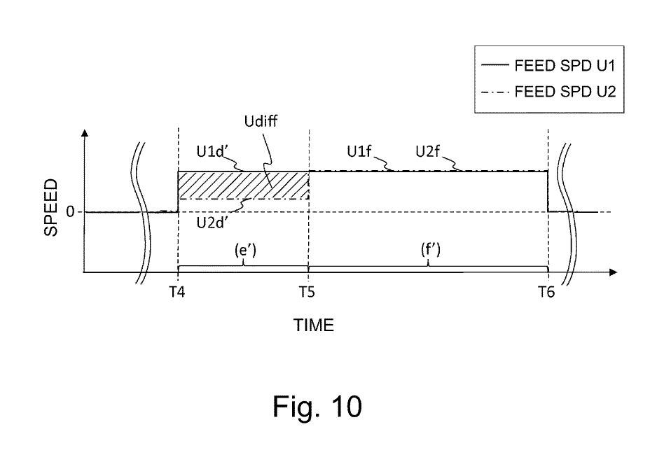

The operation for changing the sheet feeding device 51 in this embodiment in the position in which the sheet attracting member 200 is made to separate the topmost sheet Sa from the second sheet Sb by the sheet separation controlling section 210 is described. When it is necessary for the sheet feeding device 51 to be changed in the point of sheet separation, first, the sheet separation controlling section 210 obtains the information (stiffness information) about the thickness St of the sheet S from the sheet thickness detecting means 53 as shown in FIG. 9 (S101). Then, the sheet separation controlling section 210 calculates the amount of the conveyance amount difference Udiff (size of hashed area in FIG. 10), which is the amount of difference between the amount by which the first driving means 203 is driven to convey the sheet attracting member 200 in the separating period designated by (e′) in FIG. 10, and the amount by which the second driving means 204 is driven to convey the sheet attracting member 200 in the separating period designated by (e′) in FIG. 10, based on the obtained thickness information St and the table Mt1 stored in the storage area (S102).

Next, the sheet separation controlling section 210 sets the rotational speed U1d′ for the first driving means 203, and the rotational speed U2d′ for the second driving means 204, which are shown in FIG. 10, based on the calculated value of the conveyance amount difference Udiff, and the length ΔT (=T5−T4) for the separating period (S103). Then, the sheet separation controlling section 210 outputs a speed command pulse sequence to the first and second driving means 203 and 204, based on the value set in Step S103 (S104).

Through the above described steps, the sheet attracting member 200 is changed in shape, that is, in the amount of slack, in proportion to the conveyance amount difference Udiff, in the separating period. Consequently, the sheet feeding device is changed in the position of sheet separation. That is, the conveyance amount difference Udiff is equivalent to the amount by which the sheet attracting member 200 is reduced in the amount of slack between the position of full contact between the sheet attracting member 200 and the topmost sheet Sa, which is shown in FIG. 6D, and the position of separation of the topmost sheet Sa from the second sheet Sb, which is shown in FIG. 6E, as described above.

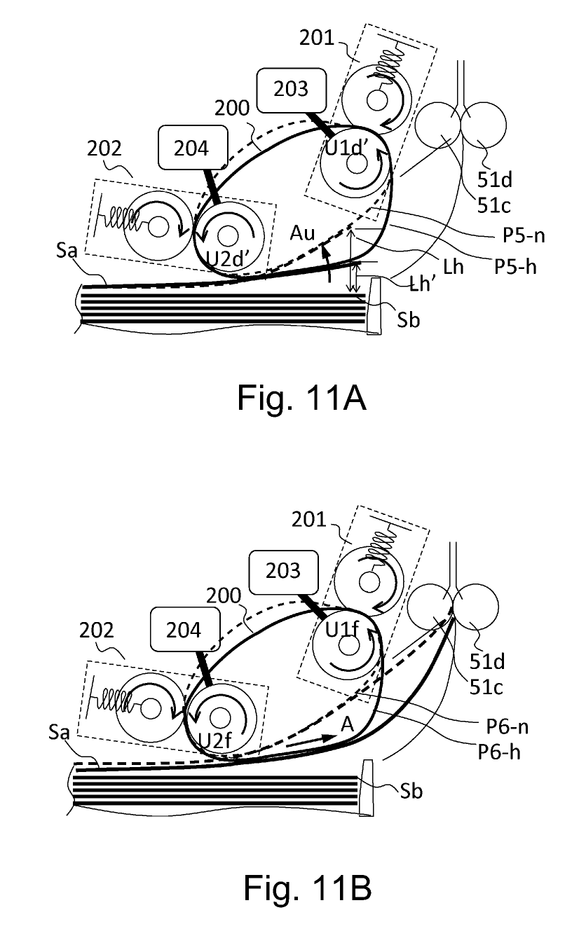

In a case where the conveyance amount difference Udiff is set to a large value, the sheet attracting member 200 increases in the amount by which the sheet attracting member 200 reduces in slack as shown in FIG. 11A. Thus, the sheet attracting side of the sheet attracting member 200 becomes roughly straight as indicated by a broken line P5-n. On the other hand, in a case where the conveyance amount difference Udiff is set to a small value, the sheet attracting member 200 reduces in the amount by which the sheet attracting member 200 reduces in the amount of slack. As a result, its shape changes as indicated by a solid line P5-h in FIG. 11A, in the direction indicated by an arrow mark Au, but, remains barrel-shaped.

Here, in this embodiment, the greater the detected value of the thickness of the sheet S, that is, the greater the sheet S in stiffness, the smaller the value to which the conveyance amount difference Udiff is set. As the conveyance amount difference Udiff is set to a small value, the height Lh of bending reduces to Lh′ shown in FIG. 11A. Reducing the height Lh of bending (to Lh′) reduces the above described “separative” force Fd shown in FIG. 8. Thus, by changing the conveyance amount difference Udiff according to the thickness of the sheet S, it is possible to keep the “separative” force Fd roughly stable in magnitude at a value which can prevent the topmost sheet Sa from separating from the sheet attracting member 200 while it is separated from the second sheet Sb.

By the way, in the feeding period shown in FIG. 11B, which follows the sheet separating period shown in FIG. 11A, the rotational speeds U1f and U2f of the first and second driving means 203 and 204, respectively, are set to the same value as described above (U1f=U2f). Therefore, the sheet attracting member 200 is rotationally moved, remaining in the altered shape indicated by a solid line P6-h or a broken line P6-n, in FIG. 11B. As the sheet attracting member 200 is rotationally moved as described above, it reaches the position of separation, in which the sheet Sa which is being electrostatically held by the sheet attracting member 200, separates from the sheet attracting member 200. By the way, if the shape of the sheet attracting member 200 is as indicated by the solid line P6-h in FIG. 11B, the sheet Sa is separates from the sheet attracting member 200 in the adjacencies of where the sheet attracting surface side of the sheet attracting member 200 becomes maximum in curvature.

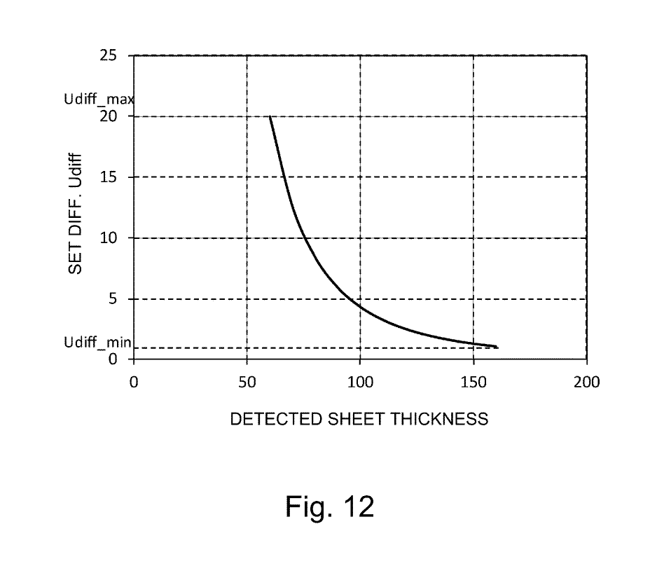

FIG. 12 is a schematic drawing of Table Mt1 which is stored in the storage area of the sheet separation controlling section 210, and which is used for setting conveyance amount difference Udiff according to the thickness of the sheet S. In this embodiment, Table Mt1 is stored in the form of a mathematical expression which shows the relationship between the thickness of the sheet S and conveyance amount difference Udiff. As for the procedure for obtaining the mathematical expression, various types of sheets are measured in thickness, and the value of conveyance amount difference Udiff is measured when the value of the separative force Fd of each type of sheet becomes a desired one. Then, the relationship between the measured thickness of each type of sheet and conveyance amount difference Udiff is approximated with the use of the least square method, and is shown in the form of a polynomial expression.

According to the researches conducted by the inventors of the present invention, if conveyance amount difference Udiff is expressed in the form of a function which is inversely proportional to the third power of the thickness of the sheet S, the values of conveyance amount difference Udiff obtained through experiments and those obtained with the use of the mathematical expression are very close to each other. In this embodiment, a mathematical expression such as the above described one is used. However, this embodiment is not intended to limit the present invention in scope. For example, even if a function expression which has been simplified with the use of various restrictions is used, it does not discord with the spirit of the present invention.

Further, Table Mt does not need to be in the form of a mathematical expression. For example, a list of the combinations of the thickness of each type of sheet S and corresponding conveyance amount difference Udiff may be made in advance and stored instead of the above described mathematical expression. Then, the stored list may be read to obtain the conveyance amount difference Udiff which most closely corresponds to the detected thickness of the sheet S.

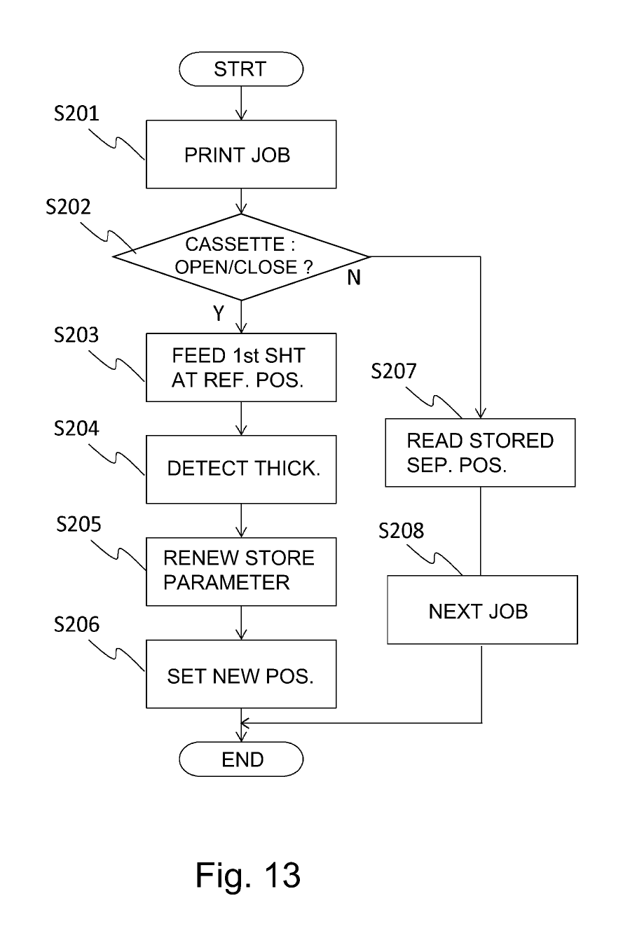

Next, referring to FIG. 13, the operation carried out by the sheet separation controlling section 210 to change the sheet attracting member 200 in the position in which the topmost sheets Sa is separated from the sheet attracting member 200 is described. FIG. 13 is a flowchart of the operational sequence carried out by the sheet separation controlling section 210 before it begins to feed the sheets S into the apparatus main assembly 100A after the inputting of a printing job.

As a printing job is inputted (S201), the sheet separation controlling section 210 detects first whether or not the cassette 51a was opened after the completion of the immediately preceding printing job, with the use of a cassette opening-closing detecting sensor disposed in the adjacencies of the cassette 51a (S202). If it detects that the cassette 51a was opened and closed (Yin S202), it feeds the first sheet S, with the conveyance amount difference Udiff set to a value set before the image forming apparatus 100 was shipped out of a factory, that is, with the sheet feeding device 51 set so that the first sheet S is separated at the normal position of separation (S203). In this embodiment, conveyance amount difference Udiff is set to the factory value, or the smallest value conveyance amount difference Udiff-min which enables the sheet attracting member 200 to feed the sheet S into the apparatus main assembly 100A in such a manner that even the thickest sheet S will not separate from the sheet attracting member 200 while being fed into the apparatus main assembly 100A.

As the sheet S reaches the area in which its thickness is detected by the sheet thickness detecting means 53 after the completion of Step S203, the thickness of the sheet S is detected by the sheet thickness detecting means 53 (S204). As the thickness of the sheet S is detected, the sheet attracting member 200 is changed in the sheet separation position by the sheet separation controlling section 210 as described above. In this step, the values of the separation position change parameters U1d′, U2d′ and ΔT, shown in FIG. 10, are stored in the unshown storage area in the sheet separation controlling section 210 (S205). Thereafter, the second sheet S and the sheets thereafter are separated in the new separation position, based on the new values of the parameters stored in S205 (S206).

On the other hand, if the sheet separation controlling section 210 determines, based on the signals from the cassette opening-closing detection sensor, that the cassette 51a has not been opened or closed (N in S202), it reads the conveyance amount difference Udiff-min, which is information about the sheet separation position stored in the storage area of the sheet separation controlling section 210 (S207). Then, it separates the sheets S using the parameters U1d′, U2d′ and ΔT, which correspond to the conveyance amount difference Udiff-min (S208).

As described above, in this embodiment, the topmost sheet Sa is separated from the second sheet Sb by the sheet attracting member 200 with the utilization of the elastic deformation of the sheet attracting member 200. Further, in the separating process, the conveyance amount difference Udiff is changed according to the thickness St of each of various types of sheet S to change the sheet feeding device 51 (sheet attracting member 200) in the sheet separation position, in order to keep the sheet S roughly stable in the magnitude of the “separative” force Fd. Therefore, it is possible to prevent the topmost sheet Sa from separating from the sheet attracting member 200 while it is fed into the apparatus main assembly 100A, and also, to minimizing the mechanical noises which occur as the sheets S are fed one by one into the apparatus main assembly 100A. That is, in this embodiment, the amount by which the sheet attracting member 200 is allowed to slack to electrostatically attract and hold the topmost sheet Sa to feed the topmost sheet Sa into the apparatus main assembly 100A is changed on the basis of the stiffness of the sheet S. Therefore, it is ensured that once the topmost sheet Sa is electrostatically held to the sheet attracting member 200, it is satisfactorily separated from the second sheet Sb. Further, it is possible to ensure that the topmost sheet Sa is reliably separated from the second sheet Sb and fed into the apparatus main assembly 100A, and also, to minimize the sheet feeding device in the amount of mechanical noises which occur as the sheets S are fed one by one into the apparatus main assembly 100A.

### Embodiment 2

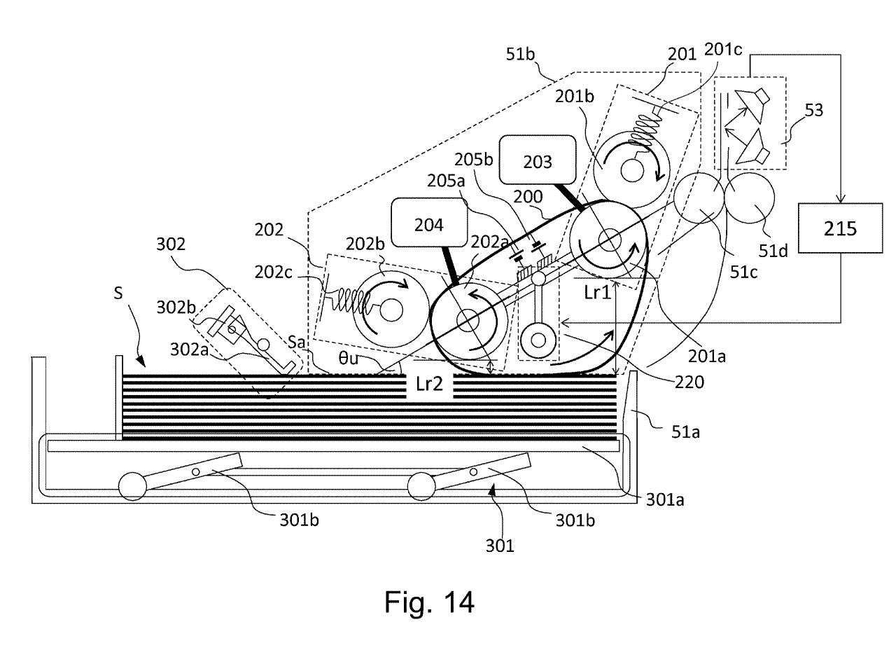

Next, the second embodiment of the present invention is described. FIG. 14 is a drawing for illustrating the structure of the sheet feeding device in this embodiment. By the way, if a structural component in FIG. 14 has the same referential code as a structural component in FIG. 12, which was described previously, the two components are the same or equivalent in structure and/or function.

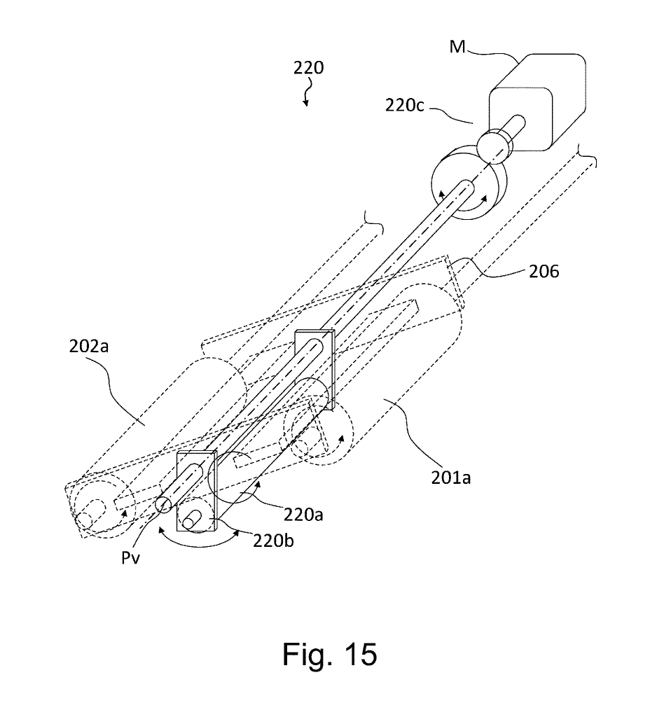

Referring to FIG. 14, a referential code 220 stands for a shape regulating section which regulates the sheet attracting member 200 in shape. This shape regulating section 220 is for pressing the inward surface of the endless sheet attracting member 200 outward from within the loop which the member 200 forms. The shape regulating section 220 which is a pressing means for pressing the inward surface of the sheet attracting member 200 is held by the frame 206, which is one of the structural components of the main assembly of the sheet feeding device, shown in FIG. 15, which will be described later, so that it is pivotally (rotationally) movable within a preset range of angle, relative to the frame 206. Thus, the sheet attracting side of the sheet attracting member 200 can be changed in shape by changing the shape regulating section 220 in attitude (angle) to change the direction in which the shape regulating section 220 is pressed (pressing position). That is, in this embodiment, the sheet attracting side of the sheet attracting member 200 is changed in shape (amount of slack) by the shape regulating section 220 to change the sheet attracting member 200 in its sheet separation position.

Referring to FIG. 15, this shape regulating section 220 has a regulating member 220a, as a pressing member, which is placed in contact with the inward surface of the sheet attracting member 200. This regulating member 220a is rotatably (pivotally) supported by a regulatory roller frame 220b, with the placement of a shaft Pv between the regulating member 220a and feeding section frame 206, and is pivotally movable about the shaft Pv by an actuator 220c equipped with a motor. By the way, in this embodiment, a rotationally supported roller is used as the regulating member 220a, the peripheral surface of which contacts the inward surface of the sheet attracting member 200. However, this embodiment is not intended to limit the present invention in scope. For example, a member formed of self-lubricating resin may be used in place of the rotationally supported roller.

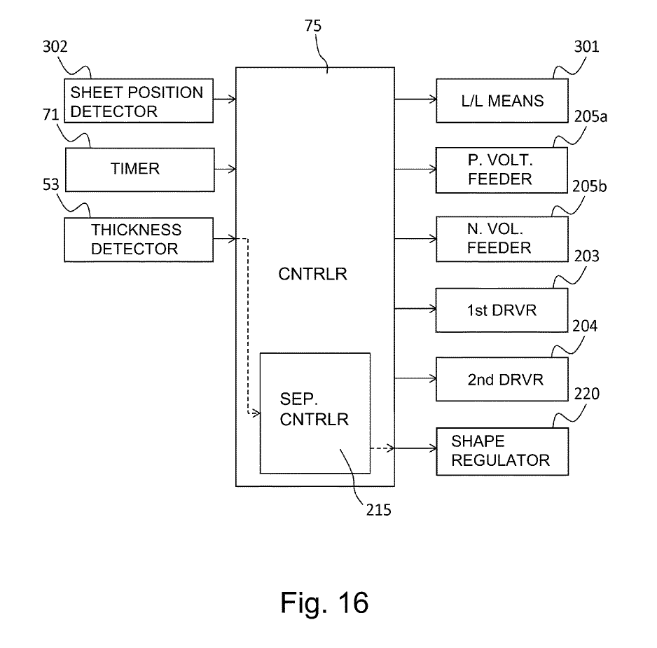

Also in this embodiment, the shape regulating section 220 is in connection to the sheet separation controlling section 215 which is stored as a subordinate system in the controlling section 70, as shown in FIG. 16. By the way, in the storage area of the sheet separation controlling section 215, and an unshown Table Mt2 used for setting angle θa for the shape regulating section 220, which is described later, is stored. The sheet separation controlling section 215 selects the sheet separation condition based on the sheet thickness detected by the sheet thickness detecting means 53, with reference to Table Mt2, and sends the angle setting command pulse sequence to the shape regulating section 220.

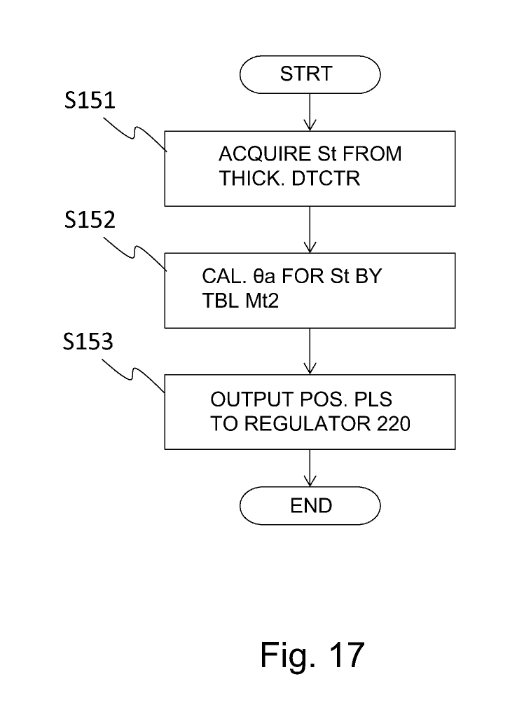

Next, referring to the flowchart in FIG. 17, the operation for changing the sheet attracting member 200 in sheet separation location with the use of the shape regulating section 220 in this embodiment is described. In this operation, first the sheet separation controlling section 215 obtains the thickness (information) St of the sheet S from the sheet thickness detecting means 53 (S151). Next, it calculates the angle θa for the shape regulating section 220, which corresponds to the obtained thickness (information) St of the sheet S, with reference to Table Mt2 stored in the storage area of the sheet separation controlling section 215 (S152). Then, it outputs an angle setting command pulse sequence to the shape regulating section 220 based on the angle θa calculated in Step S152 (S153).

Through the above described steps, the sheet attracting member 200 is changed in the shape of its slack in such a manner that the change in the shape of the slackened portion corresponds to the angle θa of the shape regulating section 220. As a result, the sheet attracting member 200 is changed in its sheet separation location. By the way, in this embodiment, it is primarily the above described length Lb of bending, shown in FIG. 8, by which the topmost sheet Sa is bent, that is changed by changing the sheet attracting member 200 in its sheet separation location.

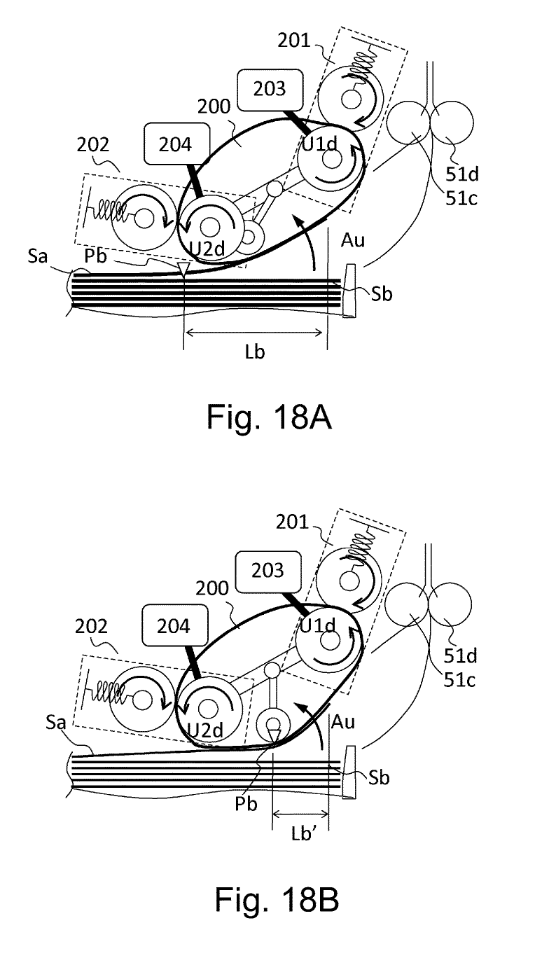

FIG. 18A shows the state of the sheet feeding device 51, in which the shape regulating section 220 is in its home position (retreat). When the sheet feeding device 51 is in the state shown in FIG. 18A, the point Pb at which the topmost sheet Sa is bent is in the adjacencies of the gap between the pair of second pinching-conveying rollers 202 and the second sheet Sb. On the other hand, after the shape regulating section 220 was changed in angle as shown in FIG. 18B, the point Pb′ at which the topmost sheet Sa is bent is in the adjacencies of the area of contact between the shape regulating section 220 and sheet attracting member 200. Here, the point Bb′ of bending of the topmost sheet Sa is closer to the leading (downstream) edge of the topmost sheet Sa than the point Pb of bending of the topmost sheet Sa. Therefore, the length Lb′ by which the topmost sheet Sa is bent is less than the length Lb of bending shown in FIG. 18A.

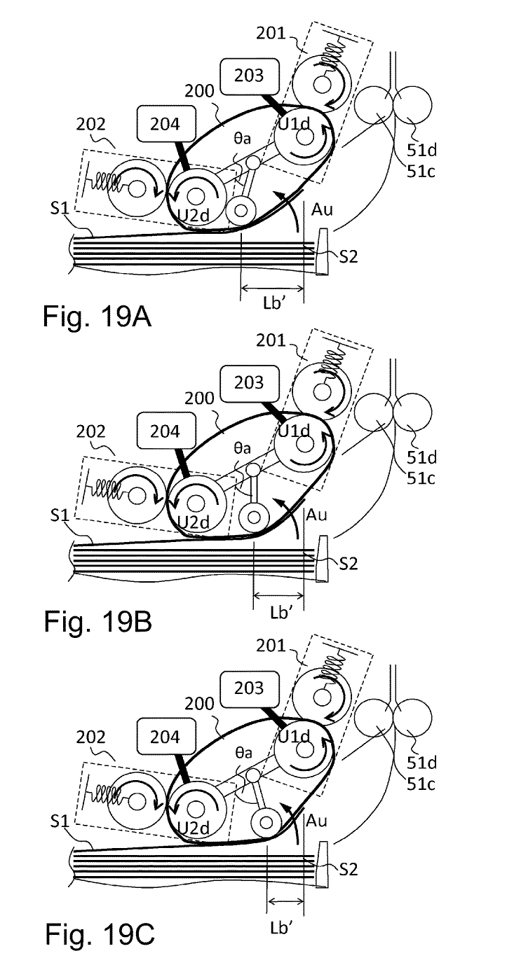

By the way, referring to FIGS. 19A, 19B and 19C, the angle θa of the shape regulating section 220, in other words, the length Lb′ of bending, also can be changed according to the location at which the sheet attracting member 200 is pressed by the shape regulating section 220. Referring to FIGS. 19A, 19B and 19C, increasing the shape regulating section 220 in angle θa moves the location at which the shape regulating section 220 presses on the sheet attracting member 200, downstream in terms of the sheet conveyance direction, and therefore, reduces the length Lb′ of bending.

Therefore, in this embodiment, the greater the sheet S in the detected thickness, that is, the greater the sheet S in stiffness, the more upstream the area in which the shape regulating section 220 contacts the inward surface of the sheet attracting member 200 is moved in terms of the direction in which the sheet attracting member 200 is rotationally moved, in order to increase the length Lb of bending. That is, the higher the sheet S in stiffness, the greater the angle by which the regulating member 220a is rotationally moved in the direction to increase the shape regulating section 220 in pressure. Thus, it is possible to keep the above described “separative” force Fd stable in magnitude roughly at a preset level which enables the sheet attracting member 200 to separate the second sheet Sb while preventing the topmost sheet Sa from separating from the sheet attracting member 200.

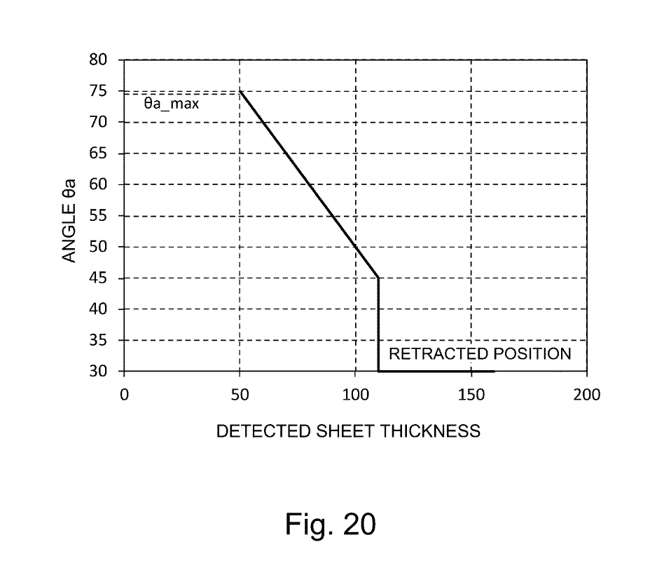

FIG. 20 is a schematic drawing of Table Mt2, which is another table for setting the angle θa for the shape regulating section 220 according to the thickness of the sheet S, and which is stored in the storage area of the sheet separation controlling section 215. In this embodiment, Table Mt2 for setting the angle θa is stored in the form of a mathematical expression which shows the relationship (function) between the angle θa and thickness of the sheet S. As for the procedure for obtaining the mathematical expression, various types of sheets S are measured in thickness, and the angle θa is measured for each of various types of sheets S when the amount of the “separative” force Fd becomes desirable. Then, the relationship between the measured thickness of the sheet S and angle θa is expressed in the form of a polynomial expression, with the use of the least square method.

It has been known through the research conducted by the inventors of the present invention that even in a case where the relationship between the angle θa and thickness of the sheet S is approximated in the form of a linear function, the values obtained with the use of the linear function closely match the values obtained by experiments. Therefore, even in a case where extremely thin sheets S or recording paper are used, the amount of the “separative” force Fd can be easily kept within a controllable range. Therefore, it is possible to increase the sheet feeding device in the selection of sheets of recording medium that can be conveyed by the sheet feeding device. However, this embodiment is not intended to limit the present invention in scope. For example, in a case where the restrictions regarding the positioning of the shape regulating section 220 or the like makes it impossible to make the regulating member 220a changeable in angle θa, all that can be done is to place the shape regulating section 220 in the shape control position or to keep the shape regulating section 220 in its home position (retreat). Even such a control does not discord with the spirit of the present invention.

Further, Table Mt2 does not need to be in the form of a mathematical expression. For example, it may be a table which contains multiple lists of relationship between the thickness of the sheet S and corresponding angle θa, which were obtained in advance. In such a case, the value of the angle θa which corresponds to the thickness St of the sheet which is closest in thickness to the sheet S which is in use in the current printing job is used in place of the value obtained with the use of the method in this embodiment to set the angle θa for the regulating member 220a.

As described above, in this embodiment, the amount by which the sheet attracting member 200 is slackened is changed by changing sheet feeding device in the area in which the sheet attracting member 200 is pressed by the shape regulating section 220, based on the stiffness of the sheet S. Thus, it is possible to change the sheet feeding device in the area in which the sheet attracting member 200 separates the topmost sheet Sa. Therefore, it is possible to keep the “separative” force Fd roughly stable in magnitude in a preset range in which the topmost sheet Sa can be satisfactorily separated from the second sheet Sb.

That is, in this embodiment, the amount by which the sheet attracting member 200 is slackened is changed with the use of shape regulating section 220, based on the amount of stiffness of the sheet S. Thus, it is ensured that once the topmost sheet Sa is electrostatically adhered to the sheet attracting member 200, it is satisfactorily separated from the second sheet Sb. Further, it is possible to minimize the sheet feeding device in operational noises, and to reliably separate the topmost sheet Sa from the second sheet Sb and feed the topmost sheet Sa into the apparatus main assembly 100A. Further, in this embodiment, the sheet feeding device is provided with the shape regulating section 220. Therefore, the sheet feeding device in this embodiment is greater in the amount by which its sheet attracting member 200 can be slackened. Thus, it is possible to feed even extremely thin sheet of recording medium (recording paper). That is, this embodiment can increase the sheet feeding device in the number of sheet types it can feed into the apparatus main assembly 100A.

### Embodiment 3

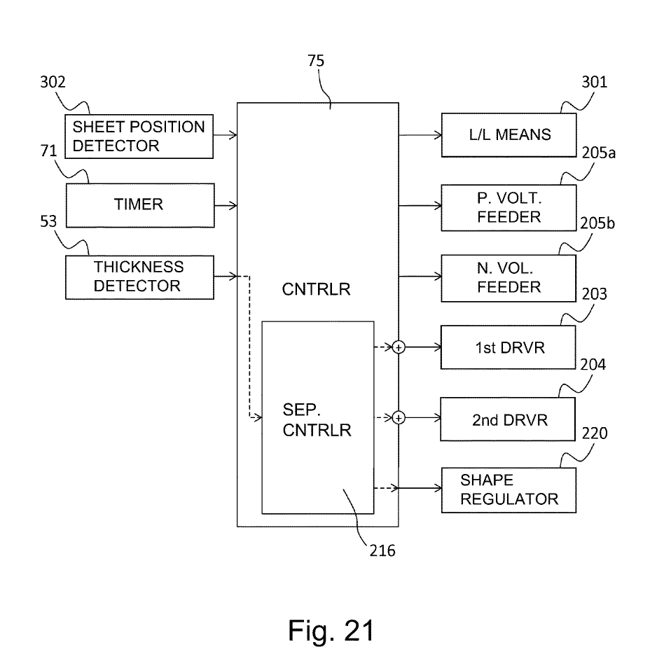

Next, the third embodiment of the present invention is described. FIG. 21 is a block diagram of the control system of the sheet feeding device 51 in this embodiment. In a case where a component, a section thereof, etc., in FIG. 21 has the same referential code as the above described component, section thereof, etc., in FIG. 5, the two are the same, or equivalent to each other.

Referring to FIG. 21, a referential code 216 stands for a sheet separation controlling section as a subordinate system in the controlling section 75. In the storage area of the this sheet separation controlling section 216, an unshown Table Mt3 for setting the angle θa for the shape regulating section 220 according to the thickness of the sheet S is stored. Also in the storage area of the sheet separation controlling section 216, an unshown Table Mt4 for calculating conveyance amount difference Udiff between the first and second driving means 203 and 204 according to the thickness of the sheet S is stored.

The sheet separation controlling section 216 sets sheet separation condition based on the thickness of the sheet S detected by the sheet thickness detecting means 53, with reference to Table Mt3, and Table Mt4. Further, the sheet separation controlling section 216 sends a positioning command pulse sequence to the shape regulating section 220 based on the set sheet separation condition, and sends a speed setting command pulse sequence to the first and second driving means 203 and 204.

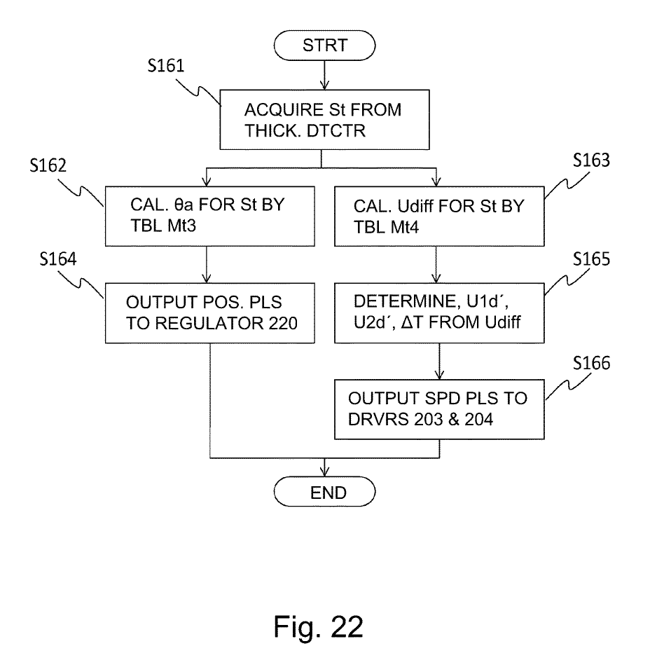

Next, referring to the flowchart in FIG. 22, the operation, in this embodiment, for changing the sheet attracting member 200 in sheet separation location, is described. In this operation, first, the sheet separation controlling section 216 obtains the information about the thickness St of the sheet S from the sheet thickness detecting means 53 (S161). Next, it calculates the angle θa for the shape regulating section 220, which corresponds to the obtained thickness information St, with reference to Table Mt3 stored in the storage area of the sheet separation controlling section 216 (S162). Further, it calculates the conveyance amount difference Udiff between the first and second driving means 203 and 204 in the separating period, which corresponds to the thickness information St, with reference to Table Mt4 (S163).

Thereafter, the sheet separation controlling section 216 outputs a positioning command pulse sequence to the shape regulating section 220, based on the angle θa calculated in Step S162 (S164). Moreover, it sets the rotational speed U1d′ for the first driving means 203, rotational speed U2d′ for the second driving means 204, and length ΔT (=T5−T4) of separating period, based on the calculated conveyance amount difference Udiff (S165). Then, it outputs speed command pulse sequence to the first and second driving means 203 and 204, based on the values set in Step S165 (S166).

Through the above described steps, the slackened portion of the sheet attracting member 200 is changed in shape in a manner to reflect the angle θa for the shape regulating section 220 and conveyance amount difference Udiff. Thus, the sheet attracting member 200 is changed in the position of the sheet separation location. In this embodiment, it is not only the length Lb of bending shown in FIG. 8, but also, the height Lh of bending, that is changed by changing the sheet attracting member 200 in its position of sheet separation.

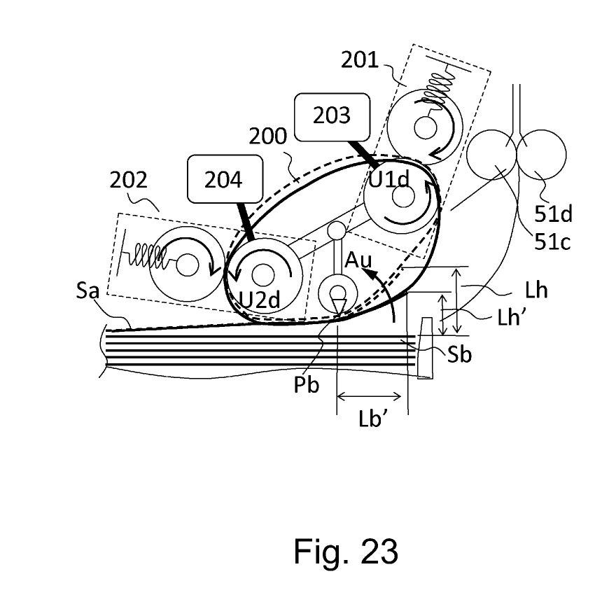

Further, when the shape regulating section 220 is positioned as shown in FIG. 23, the point Pb′ at which the topmost sheet Sa is bent is in the adjacencies of the area of contact between the shape regulating section 220 and sheet attracting member 200. Also at this point in time, the length of bending is Lb′. Further, in a case where the conveyance amount difference Udiff is set to a large value, the sheet attracting member 200 is deformed as indicated by a dotted line in FIG. 23, whereas conveyance amount difference Udiff is set to a small value, the sheet attracting member 200 is reduced in the amount by which it is reduced in the amount of slack. Consequently, the sheet attracting side of the sheet attracting member 200 is deformed in the direction indicated by an arrow mark Au as indicated by a solid line in the drawing. However, the height of bending is changed from Lh to Lh′.

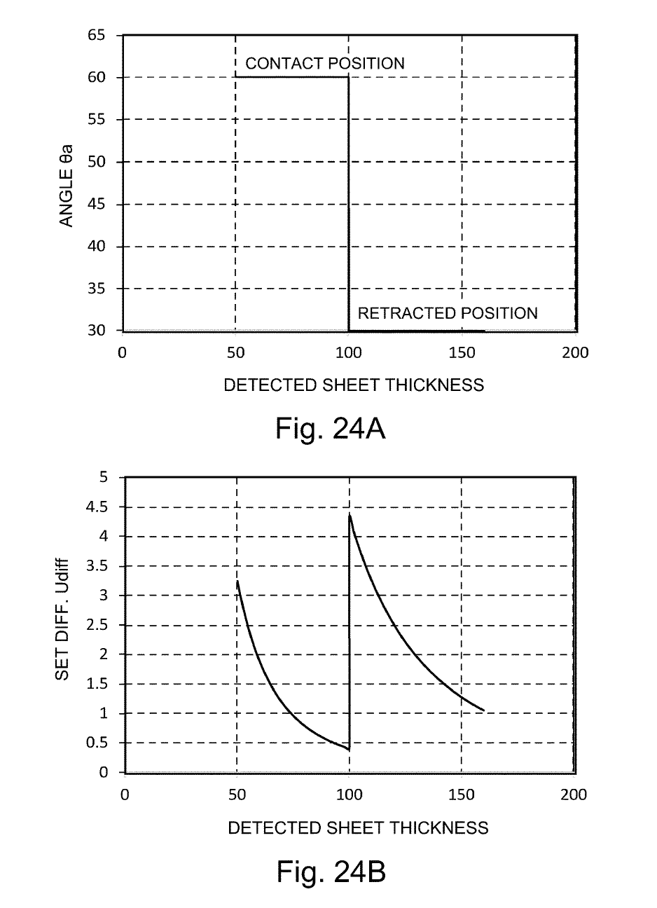

FIG. 24A is a schematic drawing of Table Mt3 stored in the storage area of the sheet separation controlling section 216 to obtain conveyance amount difference Udiff, based on the thickness of the sheet S. FIG. 24B is a schematic drawing of Table Mt4 stored in the storage area of the sheet separation controlling section 216 to obtain the angle θa for the shape regulating section 220, based on the thickness of the sheet S. By the way, the method for creating Tables Mt3 and Mt4 are basically the same as those used to create FIGS. 12 and 20.

In this embodiment, regarding the shape regulating section 220, control is executed so that in a case where the detected thickness of the sheet S is no more than 100 μm, the shape regulating section 220 is moved from its home position (retreat) to the location in which it contacts the sheet attracting member 200 as shown in FIG. 24A, whereas in case where the sheet thickness St is no less than 100 μm, the shape regulating section 220 is moved back into its home position (retreat). Regarding the conveyance amount difference Udiff, the mathematical expression is altered according to the position of the shape regulating section 220. For example, the conveyance amount difference Udiff is switched based on whether the detected sheet thickness is greater than 100 μm or not, as shown in FIG. 24B.

As described above, in this embodiment, the location in which the shape regulating section 220 presses on the sheet attracting member 200 and the conveyance amount difference Udiff are changed based on the stiffness of the sheet S to change the sheet attracting member 200 in the sheet separation location, in order to change the sheet attracting member 200 in the amount by which it is allowed to slacken while it is separating the topmost sheet Sa. Thus, it is possible to increase the sheet feeding device 51 in the number of different types of sheets it can feed, without the need to make it possible for the sheet feeding device 51 to be changeable in the angle θa for the shape regulating section 220. Because the sheet feeding device in this embodiment is structured as described above, it is possible to use an inexpensive solenoid or the like, in place of the motor M of the actuator 220c shown in FIG. 15. Therefore, it is possible to reduce a sheet feeding device in cost.

### Embodiment 4

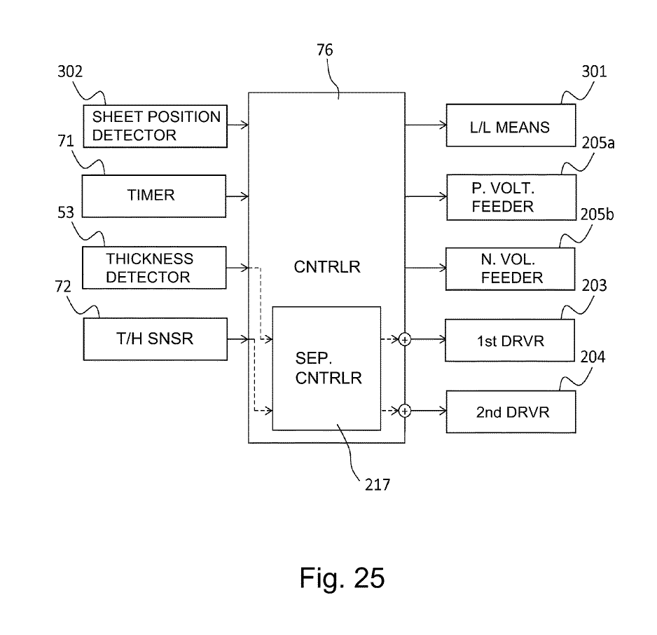

Next, the fourth embodiment of the present invention is described. FIG. 25 is a block diagram of the control sequence for the sheet feeding device 51 in this embodiment. By the way, in a case where a step in FIG. 25 has the same referential code as the above described step in FIG. 5, the two steps are the same, or equivalent to each other.

Referring to FIG. 25, a referential code 217 stands for a sheet separation controlling section as a subordinate system in the controlling section 76, and a referential code 72 stands for a temperature-humidity sensor. This temperature-humidity sensor 72 which is a means for detecting ambient temperature and humidity is in connection to the sheet separation controlling section 217. In the storage area of this sheet separation controlling section 217, unshown Table Mt5 for setting the sheet separation condition according to the sheet thickness, and the information about the temperature and humidity measured by the temperature-humidity sensor 72 are stored.

The sheet separation controlling section 217 sets the sheet separation condition based on the sheet thickness detected by the sheet thickness detecting means 53 and the information about the temperature and humidity detected by the temperature-humidity sensor 72, with reference to Table Mt5. Then, it sends a speed command pulse sequence to the first and second driving means 203 and 204, based on the set sheet separation condition.

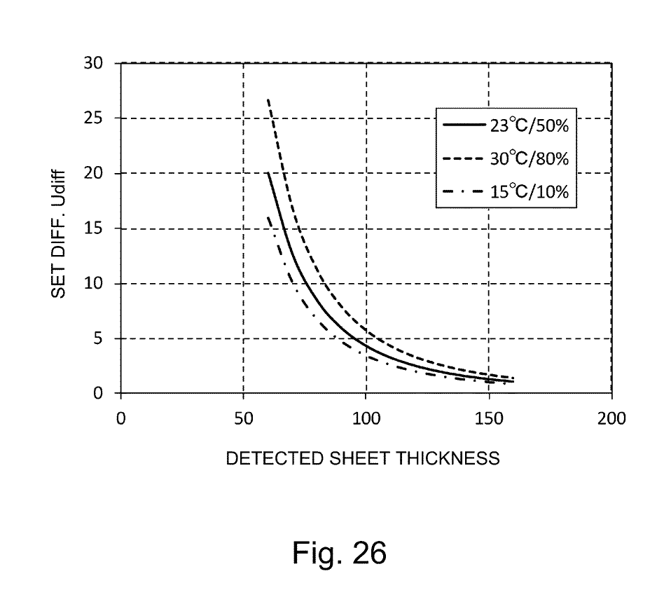

Next, referring to FIG. 26, a method for obtaining the conveyance amount difference Udiff based on the thickness of the sheet S and the information about the temperature and humidity obtained from the temperature-humidity sensor 72 is described. FIG. 26 is a schematic drawing of Table Mt5 stored in the storage area of the sheet separation controlling section 217. In this embodiment, a sheet of PPC recording paper, which is frequently used by an image forming apparatus, is used as the sheet S to be fed, that is, the object to be fed, into the apparatus main assembly 100A. It has been known that as PPC recording paper absorbs moisture in the air, it changes in stiffness.

In this embodiment, therefore, mathematical expression which show the relationship between the sheet thickness and the conveyance amount difference Udiff is obtained in advance by conducting experiments under multiple conditions which are different in temperature and humidity, and the obtained expression are stored in the storage area of the sheet separation controlling section 217. In this embodiment, three mathematical expression obtained under three different environments, that is, an environment which is 23° C. in temperature and 50% in humidity, an environment which is 30° C. in temperature and 80% in humidity, and an environment which is 15° C. in temperature and 10% in humidity, are stored. The sheet separation controlling section 217 selects the most appropriate mathematical expression, based on the information about the temperature and humidity measured by the temperature-humidity sensor 72. By the way, in this embodiment, the method for selecting the mathematical expression based on the information about the temperature and humidity is used. However, this embodiment is not intended to limit the present invention in scope. For example, such a method that a mathematical expression is obtained in advance in a specific environment, and a term which is for compensating for the change in the temperature and/or humidity is added to the mathematical expression obtained in advance, may be used instead.

As described above, in this embodiment, when the sheet attracting member 200 is changed in the sheet separation location, the information about the temperature and humidity is obtained, and the sheet attracting member 200 is adjusted in the sheet separation location. Therefore, it is ensured that the sheet feeding device can satisfactorily separate the topmost sheet Sa from the second sheet Sb under various environments. By the way, regarding the configuration of the sheet feeding device 51 in this embodiment, the sheet feeding device 51 in this embodiment is a combination of the sheet feeding device in the first embodiment and the temperature-humidity sensor 72. However, it may be a combination of the sheet feeding device in the second or third embodiment, and the temperature-humidity sensor 72.

In the above described first to fourth embodiment, the electrodes were embedded in the sheet attracting member 200 as described above, and electrostatic force (attraction) is generated between the sheet attracting member 200 and the sheet S by the application of voltage to the electrodes. These embodiments, however, are not intended to limit the present invention in scope. For example, the positive and negative electrodes 200a and 200b do not need to be in the form of a comb. That is, they may be in the form of a uniform electrode, for example, as long as they can induce an electric field in the adjacencies of the sheet attracting member 200 so that dielectric polarization occurs to the sheet S.

Further, as long as electrostatic force (attraction) is generated, a means other than those in the preceding embodiment may be used.

For example, a force that keeps the sheet S electrostatically adhered to the sheet attracting member 200 may be generated by externally charging the surface layer of the sheet attracting member 200 by placing a charge roller in contact with the dielectric surface layer of the sheet attracting member 200, on the upstream side of the intended area of contact between the sheet attracting member 200 and the sheet S, and applying voltage to the charge roller. In such a case, the electric power source which is to be connected to the charge roller may be an AC power source, or a DC power source. Moreover, in each of the above described embodiments, the sheet S is adhered to the sheet attracting member 200 with the use of the electrostatic force (attraction). However, these embodiments are not intended to limit the present invention in scope. For example, a microscopic fibrous structure of submicron order may be formed on the surface of the sheet attracting member so that the sheet S is adhered to the sheet attracting member by the intermolecular force (attraction).

By changing the sheet attracting member in the amount of its slack based on the stiffness of the sheet S while the sheet attracting member is separating the sheet S, in accordance with the present invention, it is ensured that the sheet S adhered to the sheet attracting member is separated from the sheet which is immediately under the sheet S, and also, the separated sheet S is reliably fed into the apparatus main assembly. Further, it is possible to minimize the noises attributable to the feeding of the sheet S into the apparatus main assembly.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

### INDUSTRIAL APPLICABILITY

According to the present invention, there is provided a sheet feeding apparatus capable of stably separating and feeding the sheet with less noise.

1. A sheet feeding apparatus comprising:
a stacking device stacked in g a sheet;
a first rotatable member provided above said stacking device;
a second rotatable member provided upstream of said first rotatable member with respect to a feeding direction of the sheet;
an attraction member, supported by said first rotatable member with a slack and said second rotatable member at a inner surface thereof, for electrically attracting the sheet stacked on said stacking device;
a first nipping member cooperative with said first rotatable member to nip said attraction member;
a second nipping member cooperative with said second rotatable member to nip said attraction member;
a controlling device for shifting said attraction member from a stand-by state in which said attraction member is away from the sheet accommodated in said stacking device to an attraction state in which said attraction member is elastically deformed to surface-contact with the sheet stacked on said stacking device to electrostatically attract the sheet, to a separating state for separating the sheet from a lower sheet by lifting a downstream end of the sheet with respect to the feeding direction, and to a spaced state in which said attraction member spaces the attracted sheet from the lower sheet, said controlling device changing a slackness of said attraction member in the separating state on the basis of a stiffness information of the sheet.

2. An apparatus according to claim 1, further comprising a stiffness detecting device for detecting the stiffness of the sheet, on the basis of which said controlling device controls the slackness.

3. A sheet feeding apparatus according to claim 3 further comprising,
a first driving device for driving said first rotatable member;
a second driving device for driving said second rotatable member;
a table for determining a slackness of said attraction member in the separating state in accordance with the stiffness of the sheet,
wherein said controlling device controls said first driving device and said second driving device so as to rotate said first rotatable member and said first nipping member at speeds lower than those of said second rotatable member and said second nipping member to increase the slackness of the attraction member toward a downstream, thereby shifting said attraction member from the stand-by state to the attraction state, and said controlling device controls said first driving device and said second driving device so as to rotate said second rotatable member and said second nipping member at speeds lower than those of said first rotatable member and said first nipping member to decrease the slackness of said attraction member toward a downstream, thereby shifting said attraction member from the attraction state to the separating state, wherein said controlling device changes the slackness of said attraction member in the separating state to the slackness determined on the basis of the stiffness information of the sheet supplied from said stiffness detecting device and said table.

4. A sheet feeding apparatus according to claim 3, wherein said table stores a difference between a feeding amount of said attraction member by said first rotatable member and said first nipping member from the attraction state to the separating state corresponding to the slackness of said attraction member relative to the stiffness of the sheet and a feeding amount of said attraction member of said second rotatable member and said second nipping member, wherein said controlling device changes a difference between the feeding amount of said attraction member of said first rotatable member and said first nipping member and the feeding amount of said attraction member by said second rotatable member and said second nipping member on the basis of the stiffness information of the sheet and said table.

5. A sheet feeding apparatus according to claim 4, wherein said controlling device controls said first driving device and said second driving device so that the difference between the feeding amount of said attraction member by said first rotatable member and said first nipping member and the feeding amount of said attraction member by said second rotatable member and said second nipping member decreases with increase of the stiffness of the sheet.

6. A sheet feeding apparatus according to claim 2, further comprising an urging device for urging said attraction member in the separating state at an inner surface thereof toward said stacking device in a urging position which is variable, and a second table storing the urging position of said urging device relative to the slackness of said attraction member corresponding to the stiffness of the sheet, and wherein said controlling device changes the urging position of said urging device by the stiffness information of the sheet and said second table.

7. A sheet feeding apparatus according to claim 6, wherein said urging device is rotatable and includes an urging member having a end portion contacting to the inner surface of said attraction member, and said controlling device moves the contact position of said urging member to the inner surface of said attraction member toward an upstream with respect to a feeding direction of said attraction member.

8. A sheet feeding apparatus according to claim 1, further comprising a temperature/humidity detecting device for detecting a temperature and a humidity, wherein said controlling device changes the slackness of said attraction member in the separating state on the basis of temperature/humidity information supplied by said temperature/humidity detecting device.

9. A sheet feeding apparatus according to claim 1, wherein said first rotatable member is disposed above said second rotatable member.

10. An image forming apparatus comprising an image forming station for forming an image on the sheet, and a sheet feeding apparatus according to claim 1 for feeding the sheet to said image forming station.
